(19) United States
(12) Patent Application Publication
(10) Pub. No.: US 2013/0257954 A1
(43) Pub. Date: Oct. 3, 2013

(54) LIQUID EJECTION APPARATUS AND CONTROL METHOD FOR LIQUID EJECTION APPARATUS

(71) Applicant: FUJIFILM CORPORATION, Tokyo (JP)

(72) Inventor: Tadashi KYOSO, Kanagawa (JP)

(73) Assignee: FUJIFILM CORPORATION, Tokyo (JP)

(21) Appl. No.: 13/852,902

(22) Filed: Mar. 28, 2013

(30) Foreign Application Priority Data
Mar. 29, 2012 (JP) 2012-076184

(51) Int. Cl. B41J 2/07

(52) U.S. Cl. CPC B41J 2/07
USPC 347/14

(57) ABSTRACT

A liquid ejection apparatus includes: a liquid ejection head configured to eject droplets of liquid toward a recording medium; an elevator device configured to change a distance between the liquid ejection head and the recording medium; a recording device configured to carry out recording onto the recording medium by driving the liquid ejection head to eject and deposit the droplets of the liquid onto the recording medium while driving the movement device to cause the relative movement of the liquid ejection head and the recording medium; an evaluation acquisition device configured to acquire droplet deposition performance of the liquid ejection head evaluated in accordance with results of the recording carried out on the recording medium; and a setting device configured to set the distance to as large a value as possible while satisfying droplet deposition performance required for the liquid ejection head, in accordance with the acquired droplet deposition performance.

### BACKGROUND OF THE INVENTION

1. Field of the Invention

The present invention relates to a liquid ejection apparatus and a control method for a liquid ejection apparatus, and more particularly to technology for setting an appropriate distance between a liquid ejection head and a recording medium.

2. Description of the Related Art

A known image forming apparatus is an inkjet recording apparatus, which includes an inkjet head as a recording head. The inkjet head has a nozzle face, in which nozzles configured to eject droplets of ink are arranged. The inkjet recording apparatus forms an image on a recording medium by ejecting and depositing droplets of ink onto the recoding medium by the inkjet head while conveying the recording medium relatively to the inkjet head.

In the inkjet recording apparatus, when the distance between the recording medium and the inkjet head is shortened, image quality is improved; however, problems can occur in that the recording medium rubs on the nozzle face of the inkjet head, thereby damaging the nozzle face, the recording medium strikes the nozzles, dirt becomes attached to the recording medium, and furthermore, the nozzles become clogged with paper dust, leading to ejection failures, and the like. On the other hand, when the distance between the recording medium and the inkjet head is increased, the probability of the recording medium making contact with the inkjet head is reduced; however, there is a problem in that the image quality declines.

In response to these problems, Japanese Patent Application Publication No. 2006-240231 describes an inkjet printer which is composed in such a manner that the distance between a print head and a print paper (hereinafter referred to as the “head to paper distance”) can be changed, wherein the head to paper distance is set to a narrow distance when certain image quality is required, and the head to paper distance is set to a large distance when the certain image quality is not required.

### SUMMARY OF THE INVENTION

The performances of the inkjet heads are not uniform at all times, due to variation in the initial performance and change over time, and so on. Furthermore, the required image quality varies depending on the image to be recorded, and the user.

In the technology described in Japanese Patent Application Publication No. 2006-240231, the head to paper distance is simply changed, and even when the head to paper distance is set to the narrow distance, the required image quality is not necessarily satisfied at that head to paper distance. Furthermore, when the certain image quality is not required, then it might be possible to set an even larger head to paper distance. In this way, in the technology described in Japanese Patent Application Publication No. 2006-240321, there is a drawback in that it is not possible to set an optimal head to paper distance.

The present invention has been contrived in view of these circumstances, an object thereof being to provide a liquid ejection apparatus and a control method for a liquid ejection apparatus whereby the possibility of contact between a liquid ejection head and a recording medium can be reduced as far as possible while ensuring the required recording quality.

In order to attain the aforementioned object, the present invention is directed to a liquid ejection apparatus, comprising: a liquid ejection head which has nozzles configured to eject droplets of liquid toward a recording medium; a movement device which is configured to cause relative movement of the liquid ejection head and the recording medium; an elevator device which is configured to change a distance between the liquid ejection head and the recording medium; a recording device which is configured to carry out recording onto the recording medium by driving the liquid ejection head to eject and deposit the droplets of the liquid onto the recording medium from the nozzles while driving the movement device to cause the relative movement of the liquid ejection head and the recording medium; an evaluation acquisition device which is configured to acquire droplet deposition performance of the liquid ejection head evaluated in accordance with results of the recording carried out on the recording medium; and a setting device which is configured to set the distance to as large a value as possible while satisfying droplet deposition performance required for the liquid ejection head, in accordance with the acquired droplet deposition performance.

According to this aspect of the present invention, since the droplet deposition performance of the liquid ejection head evaluated based on the recording results on the recording medium is acquired, and the distance is set to as large the value as possible based on the acquired droplet deposition performance and the droplet deposition performance required for the liquid ejection head, it is possible to reduce the possibility of contact between the liquid ejection head and the recording medium, as far as possible, while ensuring the required recording quality.

Preferably, the elevator device is configured to discretely change the distance; and the setting device is configured to set the distance to a value larger than a current value when the acquired droplet deposition performance is not worse than the required droplet deposition performance.

According to this aspect of the present invention, it is possible to set the distance between the liquid ejection head and the recording medium appropriately to as large the value as possible.

Preferably, the elevator device is configured to discretely change the distance; and the setting device is configured to set the distance to a value smaller than a current value when the acquired droplet deposition performance is worse than the required droplet deposition performance.

According to this aspect of the present invention, it is possible to set the distance between the liquid ejection head and the recording medium appropriately to as large the value as possible.

Preferably, the evaluation acquisition device is configured to previously acquire droplet deposition performances at a plurality of distances between the liquid ejection head and the recording medium; and the setting device is configured to set the distance to a largest value which satisfies the required droplet deposition performance in accordance with the acquired droplet deposition performances at the plurality of distances.

According to this aspect of the present invention, it is possible to set the distance between the liquid ejection head and the recording medium appropriately to as large the value as possible.

Preferably, the evaluation acquisition device acquires a droplet deposition performance between the plurality of distances by interpolating the acquired droplet deposition performances at the plurality of distances.

According to this aspect of the present invention, it is possible to set the distance appropriately to the largest value which satisfies the droplet deposition performance required for the liquid ejection head.

Preferably, the liquid is image forming ink; the liquid ejection head is configured to form an image on the recording medium by ejecting and depositing droplets of the image forming ink onto the recording medium; and the evaluation acquisition device is configured to acquire, as the droplet deposition performance of the liquid ejection head, deposition position deviations of the droplets having been deposited on the recording medium.

According to this aspect of the present invention, the distance between the liquid ejection head and the recording medium is set to as large the value as possible and the required image quality can be satisfied.

It is also preferable that the liquid is image forming ink; the liquid ejection head is configured to form an image on the recording medium by ejecting and depositing droplets of the image forming ink onto the recording medium; and the evaluation acquisition device is configured to acquire, as the droplet deposition performance of the liquid ejection head, an optical density of the image having been formed on the recording medium.

According to this aspect of the present invention, the distance between the liquid ejection head and the recording medium is set to as large the value as possible and the required image quality can be satisfied.

It is also preferable that the liquid is conductive ink; the recording medium is a substrate; the liquid ejection head is configured to form electrical wiring on the substrate by ejecting and depositing droplets of the conductive ink onto the substrate; and the evaluation acquisition device is configured to acquire, as the droplet deposition performance of the liquid ejection head, an electrical resistance of the electrical wiring having been formed on the substrate.

According to this aspect of the present invention, the distance between the liquid ejection head and the substrate is set to as large the value as possible and the required electrical resistance can be satisfied.

It is also preferable that the liquid is color ink; the recording medium is a substrate on which partitions are formed; the liquid ejection head is configured to form pixels of a color filter within the partitions on the substrate by ejecting and depositing droplets of the color ink within the partitions on the substrate; and the evaluation acquisition device is configured to acquire, as the droplet deposition performance of the liquid ejection head, information on whether the color ink is contained within each of the pixels of the color filter having been formed.

According to this aspect of the present invention, the distance between the liquid ejection head and the substrate is set to as large the value as possible and the required functions of the color filter can be satisfied.

Preferably, the evaluation acquisition device includes an input device which is configured to allow a user to enter results of evaluation based on the results of the recording carried out on the recording medium.

According to this aspect of the present invention, it is possible to reflect the evaluation results appropriately.

Preferably, the evaluation acquisition device includes an evaluation device which is configured to evaluate the droplet deposition performance of the liquid ejection head in accordance with the results of the recording carried out on the recording medium.

According to this aspect of the present invention, it is possible to evaluate the droplet deposition performance of the liquid ejection head automatically. Furthermore, it is also possible to evaluate the droplet deposition performance of the liquid ejection head appropriately, independently of the user.

Preferably, the nozzles of the liquid ejection head are arranged through a length corresponding to a full recordable width of the recording medium; and the movement device is configured to cause the relative movement of the liquid ejection head and the recording medium just once.

According to this aspect of the present invention, it is especially effective in a full line type of liquid ejection head.

Preferably, the liquid ejection head includes a plurality of head modules; the evaluation acquisition device is configured to acquire, as the droplet deposition performance of the liquid ejection head, droplet deposition performance of one of the head modules having lowest droplet deposition performance among the head modules; and the setting device is configured to set a distance between the head module having the lowest droplet deposition performance and the recording medium to as large a value as possible while satisfying the droplet deposition performance required for the liquid ejection head.

When the line head is constituted of the plurality of head modules, the distance needs to be set on the basis of the head module having the lowest droplet deposition performance. According to this aspect of the present invention, the time taken in acquiring the droplet deposition performance can be shortened, and the required droplet deposition performance can also be satisfied in the head modules other than the head module having the lowest droplet deposition performance.

Preferably, the liquid ejection apparatus includes: a plurality of the liquid ejection heads which are configured to eject droplets of respectively different liquids, wherein: the movement device is configured to cause relative movement of each of the liquid ejection heads and the recording medium; the elevator device is configured to change a distance between each of the liquid ejection heads and the recording medium; the evaluation acquisition device is configured to acquire droplet deposition performance of each of the liquid ejection heads evaluated in accordance with results of the recording carried out on the recording medium; and the setting device is configured to set the distance for each of the liquid ejection heads in accordance with the acquired droplet deposition performance of each of the liquid ejection heads.

According to this aspect of the present invention, even in cases where there are the plurality of the liquid ejection heads, the distances between the liquid ejection heads and the recording medium can be changed respectively, and therefore the possibility of contact between the liquid ejection heads and the recording medium can be reduced as far as possible, while ensuring the required quality in each of the liquid ejection heads.

In order to attain the aforementioned object, the present invention is also directed to a control method for a liquid ejection apparatus which includes: a liquid ejection head which has nozzles configured to eject droplets of liquid toward a recording medium; a movement device which is configured to cause relative movement of the liquid ejection head and the recording medium; an elevator device which is configured to change a distance between the liquid ejection head and the recording medium; and a recording device which is configured to carry out recording onto the recording medium by driving the liquid ejection head to eject and deposit the droplets of the liquid onto the recording medium from the nozzles while driving the movement device to cause the relative movement of the liquid ejection head and the recording medium, the method comprising: an evaluation acquisition step of acquiring droplet deposition performance of the liquid ejection head evaluated in accordance with results of the recording carried out on the recording medium; and a setting step of setting the distance to as large a value as possible while satisfying droplet deposition performance required for the liquid ejection head, in accordance with the acquired droplet deposition performance.

According to this aspect of the present invention, since the droplet deposition performance of the liquid ejection head evaluated based on the recording results on the recording medium is acquired, and the distance is set to as large the value as possible based on the acquired droplet deposition performance and the droplet deposition performance required for the liquid ejection head, it is possible to reduce the possibility of contact between the liquid ejection head and the recording medium, as far as possible, while ensuring the required recording quality.

According to the present invention, it is possible to reduce the possibility of contact between the liquid ejection head and the recording medium, as far as possible, while ensuring the required recording quality.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a side view schematic drawing showing an inkjet recording apparatus;

FIG. 2 is a block diagram showing an electrical composition of the inkjet recording apparatus;

FIG. 3 is a flowchart showing a head to paper distance adjustment process according to a first embodiment;

FIG. 4 is a flowchart showing a head to paper distance adjustment process according to a second embodiment;

FIG. 5 is a flowchart showing a head to paper distance adjustment process according to a third embodiment;

FIG. 6 is a diagram for illustrating an interpolation process for specifying a head to paper distance;

FIG. 7 is a diagram for illustrating an interpolation process for specifying a head to paper distance;

FIG. 8 is a side view schematic drawing showing an inkjet recording apparatus according to a fourth embodiment;

FIG. 9 is a flowchart showing a head to paper distance adjustment process according to the fourth embodiment;

FIG. 10 is a side view schematic drawing showing an inkjet recording apparatus according to a fifth embodiment;

FIG. 11 is a flowchart showing a head to substrate distance adjustment process according to the fifth embodiment;

FIG. 12 is a side view schematic drawing showing an inkjet recording apparatus according to a sixth embodiment;

FIG. 13 is a flowchart showing a head to substrate distance adjustment process according to the sixth embodiment;

FIG. 14 is a schematic drawing showing an image formation unit of an inkjet recording apparatus according to a further embodiment;

FIGS. 15A to 15C are plan view perspective diagrams showing a structure of a head;

FIG. 16 is a cross-sectional diagram showing an inner structure of an ink chamber unit;

FIG. 17 is a front diagram showing a structure of an installation section of a line head;

FIG. 18 is a view along arrows 18-18 in FIG. 17;

FIG. 19 is a view along arrows 19-19 in FIG. 17;

FIG. 20 is a view along arrows 20-20 in FIG. 17;

FIG. 21 is a view along arrows 21-21 in FIG. 17;

FIG. 22 is a principal block diagram showing a line head elevator control system;

FIG. 23 is a diagram showing a relationship between a rotation angle of an eccentric cam and an elevation amount of the line head;

FIG. 24 is a flowchart showing automatic gap adjustment when installing the line head;

FIG. 25 is a diagram for illustrating height variation between head modules;

FIG. 26 is a schematic drawing for illustrating an initial position setting of pedestals using a recording head jig;

FIGS. 27A and 27B are diagrams for illustrating automatic gap adjustment when installing the line head;

FIG. 28 is a flowchart showing automatic gap adjustment when replacing the line head; and

FIG. 29 is a diagram for illustrating automatic gap adjustment when replacing the line head.

### DETAILED DESCRIPTION OF THE PREFERRED EMBODIMENTS

### General Composition of Inkjet Recording Apparatus

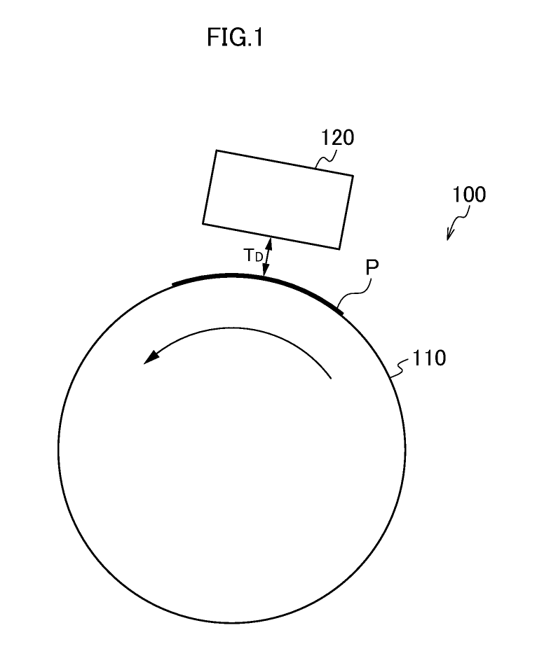

FIG. 1 is a side view schematic drawing showing an inkjet recording apparatus 100 according to an embodiment of the present invention. The inkjet recording apparatus 100 is a printer which forms an image on a recording surface of a sheet of paper P (corresponding to a recording medium), and includes an image formation drum 110 and a line head 120.

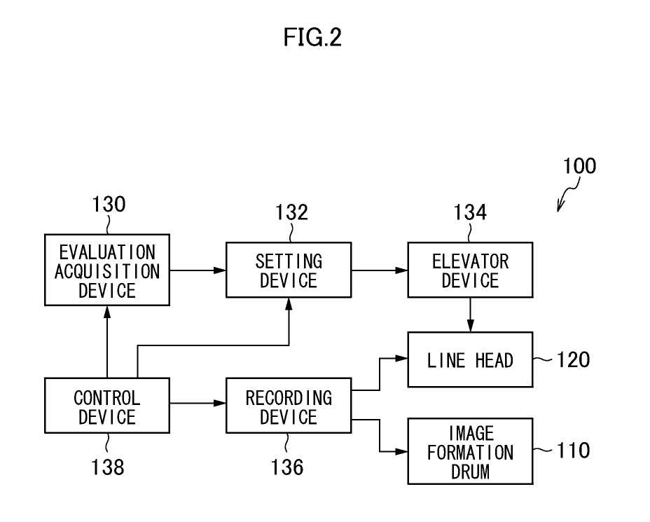

FIG. 2 is a block diagram showing an electrical composition of the inkjet recording apparatus 100. Apart from the image formation drum 110 and the line head 120, the inkjet recording apparatus 100 also includes an evaluation acquisition device 130, a setting device 132, an elevator device 134, a recording device 136, and so on.

The image formation drum 110 (corresponding to a movement device) has a circumferential surface (functioning as a conveyance surface) in which a plurality of suction holes (not shown) are formed in a prescribed pattern. The sheet of paper P that is wrapped about the circumferential surface of the image formation drum 110 is conveyed while being held by suction on the circumferential surface of the image formation drum 110 through the suction holes.

The line head 120 (corresponding to a liquid ejection head) has a nozzle face, which faces the image formation drum 110 and is formed with a plurality of nozzles arranged through a length corresponding to an entire width of the sheet of paper P. Under the control of the recording device 136 (not shown in FIG. 1), the line head 120 ejects and deposits droplets of ink from the nozzles onto a recording surface of the sheet of paper P which is conveyed by the image formation drum 110, and thereby forms an image on the recording surface of the sheet of paper P. In this way, the image is formed on the whole of the recording surface of the sheet of paper P by one conveyance action of the image formation drum 110.

Moreover, the line head 120 is provided with an elevator device 134 (not shown in FIG. 1), and is composed in such a manner that a distance from the line head 120 to the image formation drum 110 can be changed.

The setting device 132 controls the elevator device 134 and sets an elevator position for the line head 120. The setting device 132 is able to set a suitable value for the distance between the line head 120 and the recording surface of the sheet of paper P which is loaded on the conveyance surface of the image formation drum 110, by taking account of a previously input thickness of the paper P. Here, the distance between a central portion of the nozzle face of the line head 120 (the central portion in the conveyance direction of the paper P) and the recording surface of the sheet of paper P loaded on the conveyance surface of the image formation drum 110 is defined as a head to paper distance T_{D}.

The mechanism for changing the head to paper distance T_{D} is not limited to a mode which raises and lowers the line head 120. It is also possible to raise and lower the image formation drum 110, or to adopt a mode which moves both the image formation drum 110 and the line head 120.

The evaluation acquisition device 130 is a device which acquires evaluation results of droplet deposition performance of the line head 120, and a detailed description thereof is given below. The setting device 132 sets the elevator position of the elevator device 134 on the basis of the evaluation results acquired by the evaluation acquisition device 130.

The control device 138 performs overall control of the evaluation acquisition device 130, the setting device 132 and the recording device 136 in the inkjet recording apparatus 100.

### <First Embodiment>

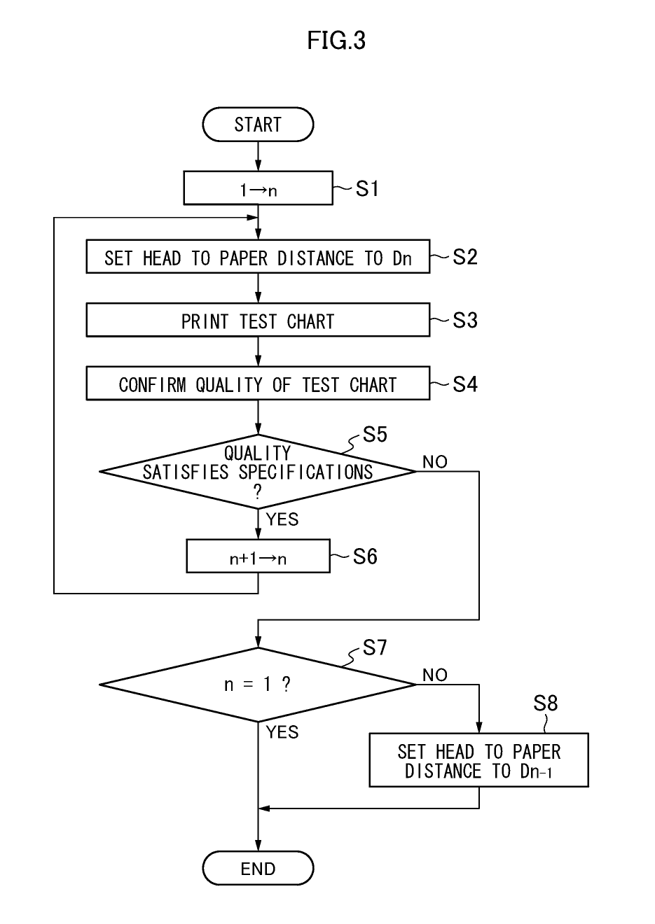

A method for adjusting the head to paper distance in a first embodiment of the present invention is now described with reference to a flowchart shown in FIG. 3. The processing of each step in the flowchart is executed under the control of the control device 138.

The adjustment of the head to paper distance is carried out before a printing job, for example. The printing job means carrying out printing of all instructed images. The adjustment can also be carried out when the power supply to the inkjet recording apparatus 100 is turned on, or when the type of paper P is changed.

In the present embodiment, the head to paper distance T_{D} can be set in five steps of D₁ to D₅. The head to paper distances in the respective steps Dₙ (here, n is an integer from 1 to 5) are, for example: D₁=0.50 mm, D₂=0.75 mm, D₃=1.00 mm, D₄=1.25 mm and D₅=1.50 mm, i.e., the relationship Dₙ<Dₙ₊₁ is satisfied. The inkjet recording apparatus 100 produces better image quality, the shorter the head to paper distance.

<Step S1>

The variable n set in the setting device 132 is initialized to 1.

<Step S2: Setting Step>

The setting device 132 controls the elevator device 134 to set the head to paper distance to Dₙ. For example, when the procedure has transferred from step S1, the elevator position of the elevator device 134 is set in such a manner that the head to paper distance is D₁=0.50 mm. Here, the thickness of the sheet of paper P has been input previously to the setting device 132.

Furthermore, when the head to paper distance is changed, the recording device 136 needs to change the ejection timings of ink droplets from the line head 120 in accordance with the amount of change. More specifically, since the head to paper distance corresponds to the flight distance of ink droplets ejected from the line head 120, then in order to deposit an ink droplet onto a desired position on the sheet of paper P, it is necessary to eject the ink droplet at a timing which is determined correspondingly to the speed and flight distance of the ink droplet.

<Step S3: Recording Step>

Next, the recording device 136 prints a chart onto the sheet of paper P at the head to paper distance Dₙ set in step S2. It is preferable that the chart printed here is the same with a chart that is to be printed after the adjustment of the head to paper distance. It is also possible to print a test chart for confirming image quality which has been previously stored in the inkjet recording apparatus 100.

<Step S4: Evaluation Acquisition Step>

Next, the image quality of the chart printed in step S3 (which corresponds to the droplet deposition performance) is confirmed. Here, the confirmation is carried out on the basis of the visual inspection, by the user, of the presence or absence of deposition position deviation of the ink droplets and density (optical density) non-uniformities. The user enters the confirmed image quality to the evaluation acquisition device 130 through an input device arranged therein.

<Step S5: Judgment Step>

The setting device 132 judges whether or not the quality of the printed chart has satisfied the required image quality (specifications), on the basis of the image quality input to the evaluation acquisition device 130.

If the required image quality is satisfied, then the procedure transfers to step S6, and if it is not satisfied, then the procedure transfers to step S7.

<Step S6>

The setting device 132 increases n by 1, and proceeds to step S2. At step S2, the head to paper distance is set to Dₙ and the processing in steps S3 to S5 is similarly carried out.

If it is judged that the quality of the printed chart satisfies the required image quality, then this means that there is scope to further increase the head to paper distance. Consequently, the head to paper distance is further increased, a chart is newly printed, and it is judged whether or not the required image quality is satisfied.

For example, if it is judged that the required image quality is satisfied at D₁=0.50 mm, then the head to paper distance is changed to D₂=0.75 mm, and a chart is newly printed. It is then judged whether or not the newly printed chart satisfies the required image quality.

Similarly, if it is judged that the required image quality is satisfied at D₂=0.75 mm, then the head to paper distance is changed to D₃=1.00 mm, and a chart is newly printed.

<Step S7>

At step S6, if it is judged that the quality of the printed test chart does not satisfy the specifications, then the setting device 132 judges whether or not n=1.

If n=1, then the head to paper distance is established at D₁=0.50 mm, and the head to paper distance adjustment process is terminated. In other words, the head to paper distance cannot be further reduced, and therefore the head to paper distance D₁ is set.

If n≠1, then the procedure advances to step S8.

<Step S8>

If n≠1, then the setting device 132 sets the head to paper distance to Dₙ₋₁ and terminates the head to paper distance adjustment process. More specifically, since the quality of the test chart printed at the head to paper distance Dₙ does not satisfy the required image quality, then the head to paper distance is taken one step back and set to the distance that satisfies the required image quality.

In this way, the head to paper distance is set in the setting step, the chart is printed in the recording step, the image quality of the chart printed in the evaluation acquisition step is acquired, it is judged in the judgment step whether or not the acquired image quality satisfies the required image quality, and if it satisfies the required image quality, the procedure returns to the setting step and sets the head to paper distance to a larger value.

Thus, by gradually increasing the head to paper distance while confirming the printed image quality, and determining the largest value of the head to paper distance which still satisfies the required image quality, it is possible to reduce the possibility of collision between the head and the sheet of paper, as far as possible, while ensuring the required image quality.

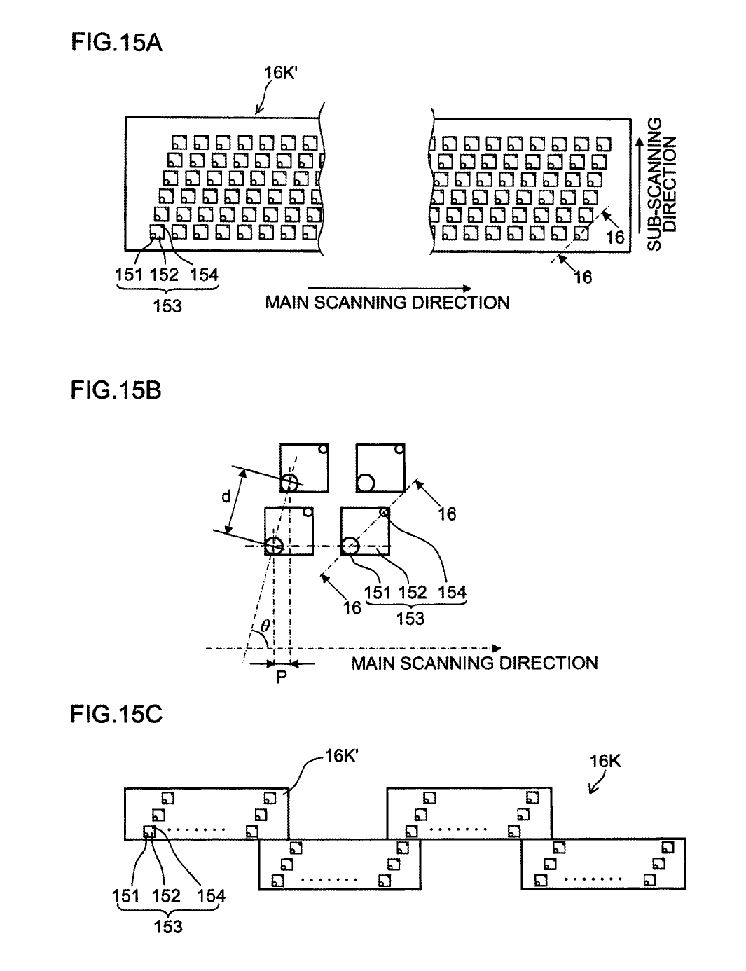

The line head 120 can be composed of a plurality of head modules (see FIGS. 15A to 15C), and the distance between the head and the sheet of paper P can vary between the respective head modules, due to installation errors, and the like. In this case, the head to paper distance can be adjusted with reference to the head module having the lowest image quality, of the plurality of head modules. In other words, the distance between the sheet of paper P and the head module having the lowest image quality is treated as the head to paper distance, and the head to paper distance is adjusted while confirming the image quality of the head module having the lowest image quality.

By setting the head to paper distance in this way, it is possible to shorten the time taken to confirm image quality, and the required image quality can be satisfied in the head modules other than the head module having lowest image quality.

Furthermore, in the present embodiment, the adjustment of the head to paper distance of one line head 120 is described; however, depending on the inkjet recording apparatus, there are also cases where line heads are arranged respectively for a plurality of ink colors.

In this case, each of the line heads is provided with an elevator device capable of changing the head to paper distance, the image quality is acquired for each line head, and the head to paper distance is adjusted for each line head.

### <Second Embodiment>

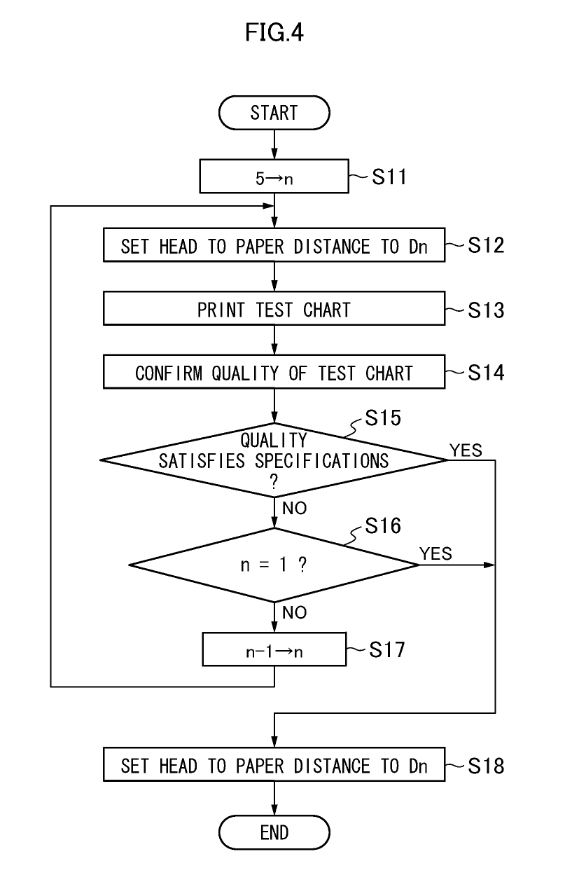

A method for adjusting the head to paper distance in a second embodiment of the present invention is now described with reference to a flowchart shown in FIG. 4. Similarly to the first embodiment, the adjustment of the head to paper distance is carried out before the printing job. Furthermore, the head to paper distance can be set in five steps, D₁=0.50 mm, D₂=0.75 mm, D₃=1.00 mm, D₄=1.25 mm and D₅=1.50 mm.

<Step S11>

The variable n set in the setting device 132 is initialized to 5.

<Steps S12 to S15>

The head to paper distance is set to Dₙ. For example, if n=3, then the head to paper distance is controlled in such a manner that D₃=1.00 mm.

Next, a chart is printed at the head to paper distance Dₙ and the quality of the printed chart is confirmed. Similarly to the first embodiment, a visual inspection is carried out by the user to confirm the presence or absence of droplet deposition position deviation and density non-uniformity.

It is then judged whether or not the quality of the printed chart satisfies the required image quality. If the printed chart does not satisfy the required image quality, then the procedure transfers to step S16, and if it satisfies the required image quality, then the procedure transfers to step S18.

<Step S16>

It is then judged whether or not n=1, in other words, whether the current head to paper distance is set to D₁. If the head to paper distance is D₁, then the procedure transfers to step S18, and if it is not D₁, then the procedure transfers to step S17.

<Step S17>

The setting device 132 decreases n by 1, and proceeds to step S12. At step S12, the head to paper distance is set to Dₙ and the processing in steps S13 to S15 is similarly carried out.

If it is judged that the quality of the printed chart does not satisfy the required image quality, then this means that the head to paper distance needs to be further decreased. Consequently, the head to paper distance is further decreased, a chart is newly printed, and it is judged whether or not the required image quality is satisfied.

For example, if it is judged that the required image quality is not satisfied at D₃=1.00 mm, then the head to paper distance is changed to D₂=0.75 mm, and a chart is newly printed. It is then judged whether or not the newly printed chart satisfies the required image quality.

However, if n=1, it is not possible to further decrease the head to paper distance, and therefore at step S16 it is judged whether or not n=1, and if n=1, then the head to paper distance is established as D₁=0.50 mm.

<Step S18>

If it is judged at step S15 that the quality of the printed chart satisfies the required image quality, or if it is judged at step S16 that n=1, then the head to paper distance is established as Dₙ, and the head to paper distance adjustment process is terminated.

In this way, the head to paper distance is set in the setting step, the chart is printed in the recording step, the image quality of the chart printed in the evaluation acquisition step is acquired, it is judged in the judgment step whether or not the acquired image quality satisfies the required image quality, and if it does not satisfy the required quality, the procedure returns to the setting step and sets the head to paper distance to a smaller value.

As described above, by gradually decreasing the head to paper distance while confirming the printed image quality, and determining the largest value of the head to paper distance which still satisfies the required image quality, it is possible to reduce the possibility of collision between the head and the paper, as far as possible, while ensuring the required image quality.

### <Third Embodiment>

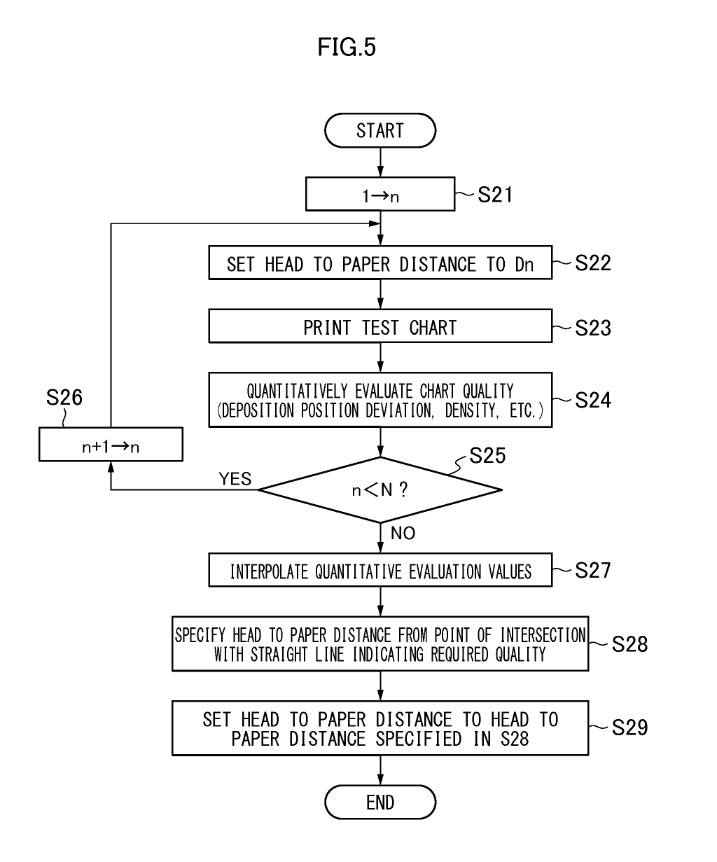

A method for adjusting the head to paper distance in a third embodiment of the present invention is now described with reference to a flowchart shown in FIG. 5. Similarly to the foregoing, the adjustment of the head to paper distance is carried out before the printing job. Furthermore, in the present embodiment, the head to paper distance can be set in N=2 steps: D₁=0.50 mm and D₂=1.50 mm.

<Step S21>

The variable n set in the setting device 132 is initialized to 1.

<Step S22>

The head to paper distance is set to Dₙ. For example, when the procedure has transferred from step S21, the head to paper distance is controlled in such a manner that D₁=0.50 mm. The thickness of the sheet of paper P has been input previously to the setting device 132.

<Step S23>

Next, a test chart is printed on the paper P at the head to paper distance Dₙ set in step S22. The test chart image is previously stored in the inkjet recording apparatus 100.

<Step S24>

Next, the quality of the printed test chart is quantitatively evaluated. An indicator for quantitatively evaluating the image quality is, for example, the standard deviation of the amounts of deviations of the deposition positions (deposition position errors) of the ink droplets ejected from the nozzles of the line head 120. In the present specification, the standard deviation of the amounts of deviations of the deposition positions is referred to as the deposition position deviation σ (μm).

Here, in step S23, the test chart for measuring the deposition position deviation σ is printed. Furthermore, the printed test chart is read in through a high-resolution scanner, or the like, the deposition positions of the ink droplets are measured for the respective nozzles, and the deposition position deviation σ is calculated. The deposition position deviation σ thus calculated is input to the evaluation acquisition device 130.

<Step S25>

It is then judged whether or not n<N. In other words, it is judged whether or not the head to paper distance Dₙ can be further increased. If n<N, then the procedure transfers to step S26, and if it is not n<N, then the procedure transfers to step S27.

<Step S26>

The setting device 132 increases n by 1, and proceeds to step S22. In other words, if the head to paper distance Dₙ can be further increased, then the head to paper distance is increased by one step and the processing in steps S23 and S24 is similarly carried out.

<Step S27>

When the quantitative evaluations of the image quality of the test charts for the head to paper distances D₁ to D_{N} have been completed, the evaluation acquisition device 130 interpolates quantitative evaluation values for the head to paper distances.

<Step S28>

Then, the evaluation acquisition device 130 specifies the head to paper distance from the point of intersection with a straight line which indicates the required image quality (standard value).

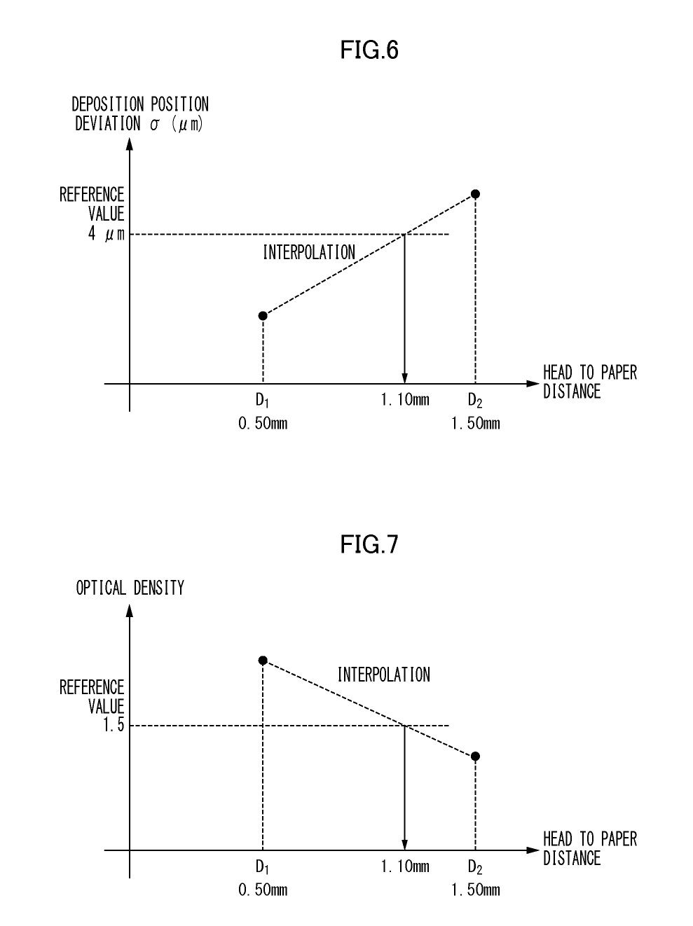

FIG. 6 is a graph for describing the head to paper distance adjustment process in the present embodiment. As shown in FIG. 6, the values of the deposition position deviation σ with the head to paper distance of D₁ and the deposition position deviation σ with the head to paper distance of D₂, which have been calculated in steps S22 to S24, are plotted on the graph. In this way, there is a correlation between the head to paper distance and the deposition position deviation σ.

Then, the values of the deposition position deviation σ between D₁ and D₂ are interpolated by the straight line which links the two plotted points. The method for interpolating between the two points is not limited to the linear interpolation and if the change in the data between the two points is known, then the data can be interpolated using the corresponding formula. From the viewpoint of interpolation accuracy, it is desirable that the deposition position deviations u at not less than 3 points are calculated and the data between these points is interpolated.

Then, a straight line parallel to the X axis (horizontal axis) is drawn on the graph at the reference value of the deposition position deviation σ that indicates the required image quality. In the present embodiment, the reference value of the deposition position deviation σ is set to 4 μm.

The X coordinate of the intersection point of the two straight lines is the head to paper distance for that line head. Here, as shown in FIG. 6, the head to paper distance is specified as 1.1 mm (step S29).

The setting device 132 controls the elevator device 134 in such a manner that the head to paper distance is the distance specified in step S28. In the example described above, the head to paper distance is set to 1.1 mm.

Thus, by quantitatively evaluating the printed test chart while changing the head to paper distance and specifying the head to paper distance on the basis of the quantitative evaluation value and the required quality reference value, it is possible to reduce the possibility of collision between the head and the paper, as far as possible, while ensuring the required image quality.

In the present embodiment, the deposition position deviations σ are acquired for the plurality of head to paper distances, and the head to paper distance that corresponds to the reference value of the deposition position deviation σ is determined by interpolating the data between the acquired values; however, it is also possible to determine the head to paper distance that corresponds to the reference value of the deposition position deviation σ by segmenting the head to paper distances which are subjected to the quantitative evaluation.

### <Modification of Third Embodiment>

In the third embodiment, the deposition position deviation σ of the printed test chart is used for the quantitative evaluation of the image quality; however, it is also possible to use other indicators for making quantitative evaluation. Here, an example is described in which the other indicator is the optical density of the printed test chart.

FIG. 7 is a graph which plots the value of the optical density of the test chart printed at the head to paper distance of D₁ and the value of the optical density of the test chart printed at the head to paper distance of D₂.

Each test chart has a density patch of a prescribed density, and the density patch is read in through a scanner, or the like, and the optical density of each test chart is calculated. If there is a large amount of deposition position deviation of the ink droplet ejected from each of the nozzles, then the optical density tends to fall. Consequently, the higher the optical density, the higher the image quality.

Here, the values of the optical densities between D₁ and D₂ are interpolated by the straight line which links the two plotted points. Then, a straight line parallel to the X axis (horizontal axis) is drawn on the graph at the reference value of the optical density that indicates the required image quality. In the present embodiment, the reference value of the optical density is set to be 1.5.

The X coordinate of the intersection point of the two straight lines is the head to paper distance for that line head. Here, as shown in FIG. 7, the head to paper distance is specified as 1.1 mm.

Thus, it is also possible to use the optical density of the printed test chart for the quantitative evaluation of the image quality.

### <Fourth Embodiment>

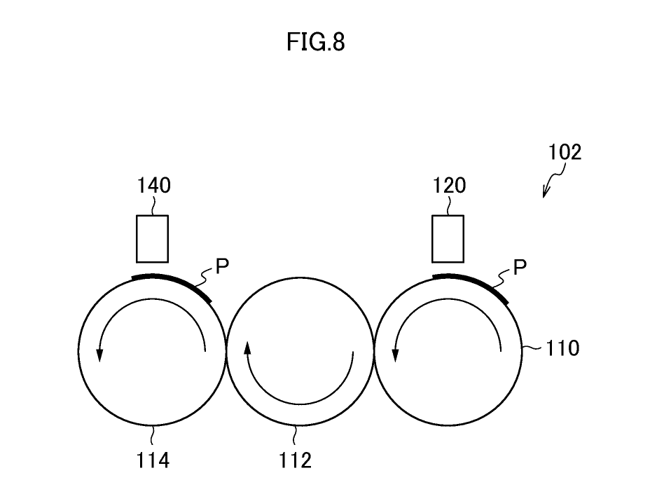

FIG. 8 is a side view schematic drawing showing an inkjet recording apparatus 102 according to an embodiment of the present invention. The parts which are the same as or similar to those of the inkjet recording apparatus 100 shown in FIG. 1 are denoted with the same reference numerals, and detailed explanation thereof is omitted here. The inkjet recording apparatus 102 includes conveyance drums 112 and 114 and an in-line sensor 140, in addition to the image formation drum 110 and the line head 120. In the present embodiment, the head to paper distance can be set in 10 steps: D₁ to D₁₀ which satisfy the relationship Dₙ<Dₙ₊₁.

Each of the conveyance drums 112 and 114 also has a circumferential surface (functioning as a conveyance surface) in which a plurality of suction holes (not shown) are formed in a prescribed pattern, similarly to the image formation drum 110, and the sheet of paper P is conveyed by being held by suction on the circumferential surface thereof.

The sheet of paper P on which an image has been formed on the recording surface thereof by the line head 120 is transferred from the image formation drum 110 to the conveyance drum 112, and is then transferred from the conveyance drum 112 to the conveyance drum 114.

The in-line sensor 140 captures the image formed on the recording surface of the sheet of paper P held by suction on the conveyance drum 114.

The in-line sensor 140 is a device which reads in the image formed on the recording surface of the sheet of paper P, and determines the image density and the deposition position deviation of the dots, and the like. The in-line sensor 140 can be constituted of a CCD line sensor, or the like. The determination results of the in-line sensor 140 are input to the evaluation acquisition device 130.

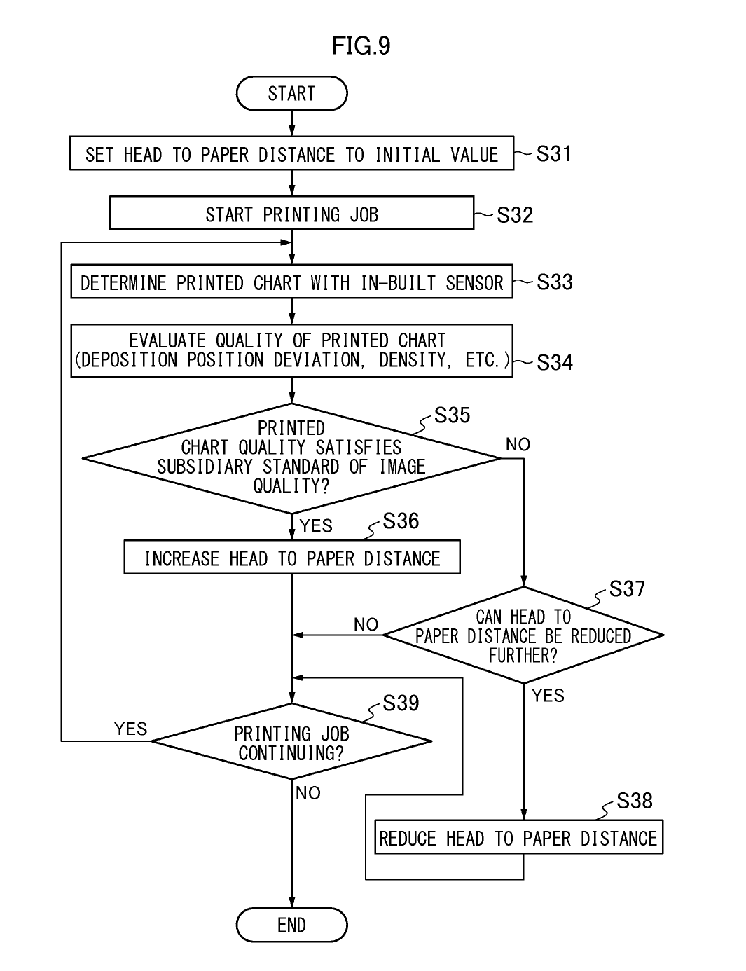

Next, a method for adjusting the head to paper distance according to the present embodiment is described with reference to a flowchart shown in FIG. 9. In the present embodiment, the head to paper distance is controlled to an optimal value during a printing job.

<Step S31>

The setting device 132 sets the head to paper distance to an initial value. It is desirable that the initial value is previously specified by any of the methods described in the embodiments given above. Furthermore, it is also possible to specify a generally used value as the initial value.

<Step S32>

A printing job is started upon an instruction issued by the user. When the printing job is started, the recording device 136 makes a plurality of sheets of paper P be successively conveyed to the image formation drum 110. Furthermore, a chart is formed on the recording surface of each of the sheets of paper P by the linear head 120.

<Step S33>

The in-line sensor 140 determines the chart formed on the recording surface of the sheet of paper P. The image which is determined here can be a test chart image formed in a margin of the sheet of paper, rather than an image of the printing job instructed by the user.

<Step S34>

The chart image determined by the in-line sensor 140 is input to the evaluation acquisition device 130, and the image quality thereof is evaluated. The evaluation acquisition device 130 evaluates the deposition position deviation σ or the optical density, for example.

<Step S35>

The setting device 132 judges whether or not the image quality of the chart evaluated by the evaluation acquisition device 130 satisfies a subsidiary standard of the image quality. The “subsidiary standard of the image quality” is a value that has a spare margin with respect to the “required image quality” used in the first to third embodiments. More specifically, the subsidiary standard of the image quality is a value according to which, in a state where a head to paper distance satisfies the subsidiary standard, even when the head to paper distance is increased by one step from this state, the required image quality can still be satisfied.

If the subsidiary standard of the image quality is satisfied, then the procedure transfers to step S36. If the subsidiary standard of the image quality is not satisfied, then the procedure transfers to step S37.

<Step S36>

The setting device 132 increases the head to paper distance by one step. In other words, the setting device 132 increases n by 1, and sets the head to paper distance to Dₙ.

If it is judged that the quality of the printed chart satisfies the subsidiary standard of the image quality, this means that there is scope to further increase the head to paper distance. Then, the head to paper distance is increased.

<Step S37>

It is judged whether or not the head to paper distance can be further reduced. If the head to paper distance can be reduced, then the procedure advances to step S38. If the head to paper distance cannot be reduced, then the procedure advances to step S39.

<Step S38>

The setting device 132 decreases the head to paper distance by one step. In other words, the setting device 132 decreases n by 1, and sets the head to paper distance to Dₙ.

If it is judged that the quality of the printed chart does not satisfy the subsidiary standard of the image quality, then it is necessary to reduce the head to paper distance. Then, provided that the head to paper distance can be reduced, it is reduced.

<Step S39>

It is then judged whether or not the printing job is continuing. If the printing job has been completed, then the processing is terminated. If the printing job is continuing, then the procedure transfers to step S33 and similar processing is repeated.

Thus, by evaluating the quality of the printed chart and specifying the head to paper distance during the printing job, it is possible to maintain the optimal head to paper distance at all times.

### <Fifth Embodiment>

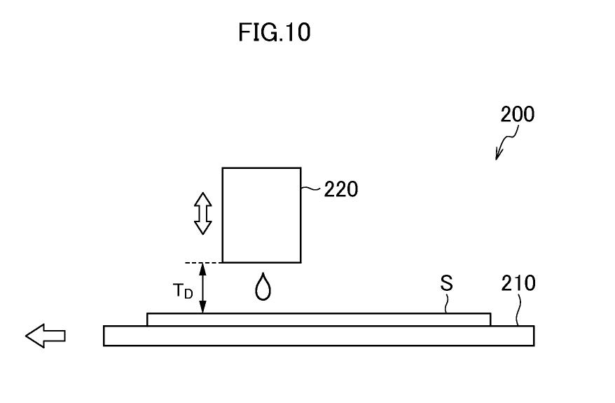

FIG. 10 is a side view schematic drawing showing an inkjet recording apparatus 200 in an embodiment of the present invention. The inkjet recording apparatus 200 is a wiring forming apparatus, which forms electrical wiring by applying conductive ink onto a surface of a substrate S, and includes a conveyance tray 210 and a line head 220.

The conveyance tray 210 conveys the substrate S loaded on the upper surface thereof in a prescribed conveyance direction. The substrate S is a base substrate of a printed circuit board, and is made from a material such as glass, glass epoxy, silicon, polyimide, or the like.

The line head 220 has a nozzle face, which faces the conveyance tray 210 and is formed with a plurality of nozzles arranged through a length corresponding to an entire width of the substrate S. Under the control of a recording device (not shown), the line head 220 ejects and deposits droplets of conductive ink (e.g., paste containing silver) from the nozzles onto the surface of the substrate S which is conveyed by the conveyance tray 210, and thereby forms an electrical wiring pattern on the surface of the substrate S.

Moreover, the line head 220 is provided with an elevator device (not shown), and is composed in such a manner that a distance from the line head 220 to the conveyance tray 210 can be changed. The inkjet recording apparatus 200 is configured to set a suitable value for the distance (hereinafter referred to as the “head to substrate distance”) between the line head 220 and the surface of the substrate S which is loaded on the conveyance surface of the conveyance tray 210, by taking account of a previously input thickness of the substrate S.

The mechanism for changing the head to substrate distance is not limited to a mode which raises and lowers the line head 220. It is also possible to raise and lower the conveyance tray 210, or to adopt a mode which moves both the conveyance tray 210 and the line head 220.

In the present embodiment, the head to substrate distance can be set in five steps of D₁ to D₅. The head to substrate distances in the respective steps Dₙ are, for example: D₁=0.50 mm, D₂=0.75 mm, D₃=1.00 mm, D₄=1.25 mm and D₅=1.50 mm.

In order that the wiring pattern, which is formed from the droplets of the conductive ink, such as the silver paste, satisfactorily functions as electrical wiring, the droplets deposited on the substrate S need to be joined together. If there are great deviations in the droplet deposition positions, then the deposited conductive ink droplets do not sufficiently overlap with each other, the electrical resistance of the wiring pattern increases, and the function as the electrical wiring is not satisfied. Furthermore, if the head to substrate distance is reduced in order to reduce the droplet deposition position deviation, then the possibility of collision between the head and the substrate rises.

Consequently, in the present embodiment, the head to substrate distance is controlled similarly to the inkjet recording apparatuses 100 and 102 in the case of image formation.

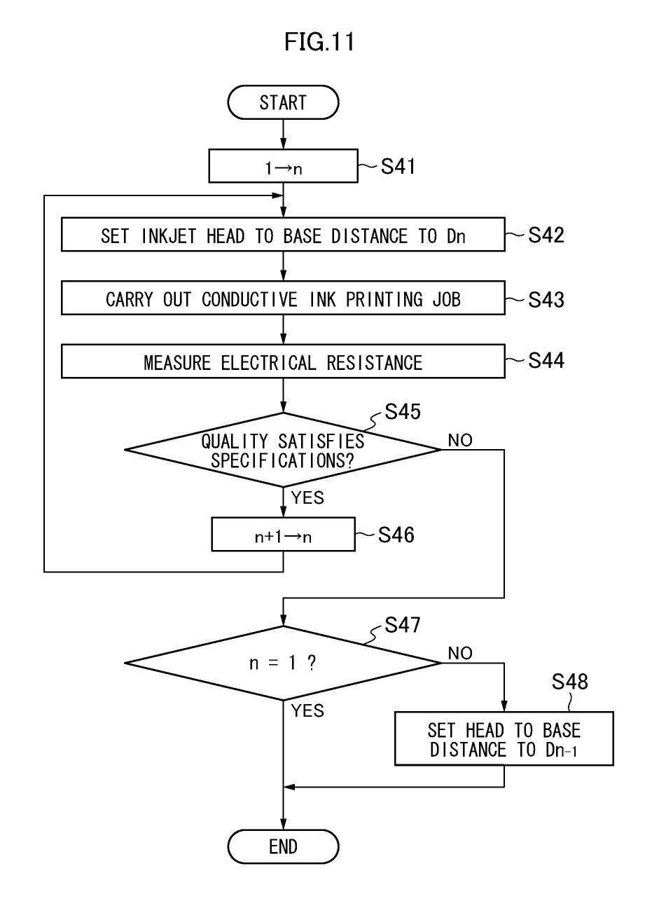

The method for adjusting the head to substrate distance is now described with reference to a flowchart shown in FIG. 11. The adjustment of the head to substrate distance is carried out before a wiring formation job.

<Step S41>

The variable n is initialized to 1.

<Step S42>

The head to substrate distance is set to Dₙ. For example, if n=4, then the elevator device of the line head 220 is controlled in such a manner that the head to substrate distance becomes D₄=1.25 mm. The thickness of the substrate S has been input previously to the inkjet recording apparatus 200. Furthermore, similarly to the foregoing, when the head to substrate distance has been changed, the ink ejection timings are changed.

<Step S43>

Next, a wiring formation job for adjusting the head to substrate distance is carried out. More specifically, a wiring pattern is formed on the substrate S at the head to substrate distance Dₙ set in step S42. It is preferable that the wiring pattern formed here is the same with a wiring pattern that is to be formed after the adjustment of the head to substrate distance.

<Step S44>

Next, the quality of the wiring pattern formed in step S43 is confirmed. Here, the electrical resistance of the wiring pattern is used as an indicator of the quality of the wiring pattern (which corresponds to the droplet deposition performance).

<Step S45>

It is judged whether or not the electrical resistance of the formed wiring pattern confirmed in step S44 satisfies the required electrical resistance (specifications). Here, the user enters the judgment results to the inkjet recording apparatus 200 through an input device (not shown) arranged therein.

If the required electrical resistance is satisfied, then the procedure transfers to step S46, and if it is not satisfied, then the procedure transfers to step S47.

<Step S46>

The variable n is increased by 1, and the procedure advances to step S42. At step S42, the head to substrate distance is set to Dₙ and the processing in steps S43 to S45 is similarly carried out.

If it is judged that the electrical resistance of the formed wiring pattern satisfies the required electrical resistance, then this means that there is scope to further increase the head to substrate distance. Consequently, the head to substrate distance is further increased, a wiring pattern is newly formed, and it is judged whether or not the required electrical resistance is satisfied.

For example, if it is judged that the required electrical resistance is satisfied at D₄=1.25 mm, then the head to substrate distance is changed to D₅=1.5 mm, and a wiring pattern is newly formed. It is then judged whether or not the newly formed wiring pattern satisfies the required electrical resistance.

<Step S47>

At step S46, if it is judged that the electrical resistance of the formed wiring pattern does not satisfy the required electrical resistance, then it is judged whether or not n=1.

If n=1, then the head to substrate distance is established at D₁=0.50 mm, and the head to substrate distance adjustment process is terminated. In other words, the head to substrate distance cannot be further reduced and therefore the head to substrate distance D₁ is set.

If n≠1, then the procedure advances to step S48.

<Step S48>

If n≠1, then the head to substrate distance is set to Dₙ₋₁ and the processing is terminated. More specifically, since the electrical resistance of the wiring pattern formed at the head to substrate distance Dₙ does not satisfy the required electrical resistance, then the head to substrate distance is taken one step back and set to the distance that satisfies the required electrical resistance.

Thus, by gradually increasing the head to substrate distance while confirming the electrical resistance of the formed wiring pattern, and determining the largest value of the head to substrate distance which still satisfies the required electrical resistance, it is possible to reduce the possibility of collision between the head and the substrate, as far as possible, while ensuring the required electrical resistance.

Moreover, as in the second embodiment, it is also possible to adopt a mode in which the head to substrate distance is gradually reduced while confirming the electrical resistance of the formed wiring pattern.

Furthermore, as in the third embodiment, it is also possible to adopt a mode in which the electrical resistance is evaluated quantitatively for each of the head to substrate distances D₁ to D_{N}, in advance, and the head to substrate distance is specified on the basis of the results of the quantitative evaluation.

### <Sixth Embodiment>

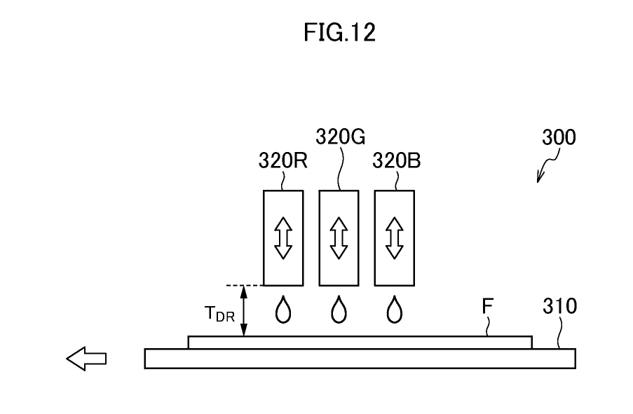

FIG. 12 is a side view schematic drawing showing an inkjet recording apparatus 300 in an embodiment of the present invention. The inkjet recording apparatus 300 is a color filter forming apparatus, which forms a color filter for a liquid crystal display by applying inks of respective colors of red (R), green (G) and blue (B), onto a surface of a color filter substrate F, and includes a conveyance tray 310 and line heads 320R, 320G and 320B of the respective colors.

The conveyance tray 310 conveys the color filter substrate F loaded on the upper surface thereof in a prescribed conveyance direction. The color filter substrate F is a base substrate on the surface of which partitions with light shielding properties having a black matrix function are formed. The color filter substrate F is made from a transparent glass substrate, for example.

Each of the line heads 320R, 320G and 320B has a nozzle face, which faces the conveyance tray 310 and is formed with a plurality of nozzles arranged through a length corresponding to an entire width of the color filter substrate F. Under the control of a recording device (not shown), the line heads 320R, 320G and 320B eject droplets of the respective color inks from the nozzles, and thereby applying the respective color inks inside the partitions on the color filter substrate F conveyed by the conveyance tray 310 and thus forming pixel areas of the respective colors.

Moreover, each of the line heads 320R, 320G and 320B is provided with an elevator device (not shown), and is composed in such a manner that a distance from each of the line heads 320R, 320G and 320B to the conveyance tray 310 can be changed. The inkjet recording apparatus 300 is configured to set a suitable value for the distance (head to substrate distance) between each of the line heads 320R, 320G and 320B and the surface of the color filter substrate F which is loaded on the conveyance surface of the conveyance tray 310, by taking account of a previously input thickness of the color filter substrate F.

In the present embodiment, the head to substrate distance can be set in five steps: D₁ to D₅. The head to substrate distances in the respective steps Dₙ are, for example: D₁=0.50 mm, D₂=0.75 mm, D₃=1.00 mm, D₄=1.25 mm and D₅=1.50 mm.

In order that the formed color filter substrate F satisfactorily functions as a color filter, the color inks need to be contained within the respective regions inside the partitions of the black matrix. If the ink droplet is deposited in other regions, then a problem of color mixing or the like occurs, and therefore the image on the liquid crystal display which uses the color filter deteriorates and the required functions cannot be satisfied. Furthermore, if the head to substrate distance is reduced in order to reduce the droplet deposition position deviation, then the possibility of collision between the head and the substrate rises.

Consequently, in the present embodiment, the head to substrate distance is controlled similarly to the inkjet recording apparatuses 100 and 102 in the case of image formation.

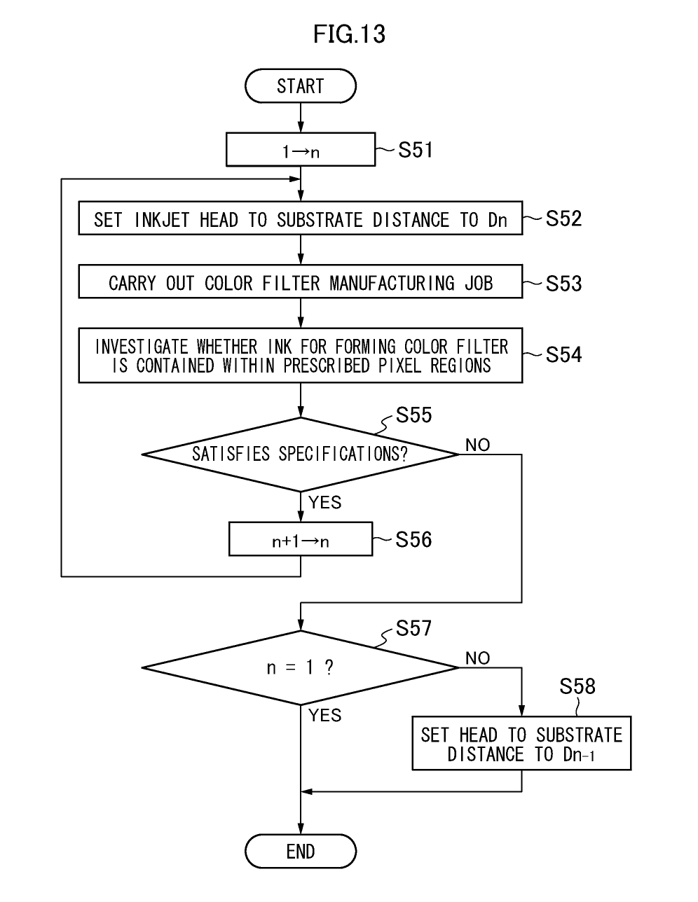

The method for adjusting the head to substrate distance is now described with reference to a flowchart shown in FIG. 13. The methods for adjusting the head to substrate distances for the line heads 320R, 320G and 320B are similar to each other, and therefore a process for adjusting the head to substrate distance for the line head 320R is described as a representative example. The adjustment of the head to substrate distance is carried out before a color filter manufacturing job.

<Step S51>

The variable n is initialized to 1.

<Step S52>

The head to substrate distance is set to Dₙ. For example, if n=3, then the elevator device of the line head 320R is controlled in such a manner that the head to substrate distance becomes D₃=1.00 mm. The thickness of the color filter substrate F has been input previously to the inkjet recording apparatus 300. Furthermore, similarly to the foregoing, when the head to substrate distance has been changed, the ink ejection timings are changed.

<Step S53>

Next, a color filter manufacturing job for adjusting the head to substrate distance is carried out. The line head 320R forms R pixels on the color filter substrate F at the head to substrate distance Dₙ set in step S52.

<Step S54>

Next, the quality of each pixel formed in step S53 is confirmed. Here, an investigation using a CCD camera is carried out to determine whether the pixel forming ink (here, the R ink) is contained within the prescribed region (within the pixel).

<Step S55>

It is judged whether or not the R ink that is not contained within the prescribed regions is less than a prescribed value (which corresponds to the droplet deposition performance), on the basis of the results of the investigation carried out in step S54. For example, if a droplet of R ink has been deposited on the black matrix or on an adjacent pixel, then it cannot be regarded as being contained within the prescribed regions. If the R ink that is not contained within the prescribed regions in this manner is not less than the prescribed value, then color mixing occurs in the G pixels and the B pixels, and it is not possible to satisfy the required functions as a color filter. Here, the user enters the judgment results to the inkjet recording apparatus 300 through an input device (not shown) arranged therein.

If the R ink that is not contained in the prescribed regions is less than the prescribed value, then the procedure transfers to step S56, and if it is not less than the prescribed value, then the procedure transfer to step S57.

<Step S56>

The variable n is increased by 1, and the procedure advances to step S52. At step S52, the head to substrate distance is set to Dₙ and the processing in steps S53 to S55 is similarly carried out.

If it is judged that the R ink that is not contained within the prescribed regions is less than the prescribed value, then this means that the R pixels have been appropriately formed, and there is scope to further increase the head to substrate distance. Consequently, the head to substrate distance is further increased, R pixels are newly formed, and it is judged whether or not the specifications are satisfied.

For example, if it is judged that the R ink that is not contained within the prescribed regions is less than the prescribed value at D₃=1.00 mm, then the head to substrate distance is changed to D₄=1.25 mm, and R pixels are newly formed. It is then judged whether or not the R ink that is not contained in the prescribed regions is less than the prescribed value.

<Step S57>

At step S56, if it is judged that the specifications are not satisfied, then it is judged whether or not n=1. If n=1, then the head to substrate distance is established at D₁=0.50 mm, and the head to substrate distance adjustment process is terminated. In other words, the head to substrate distance cannot be further reduced and therefore the head to substrate distance D₁ is set.

If n≠1, then the procedure advances to step S58.

<Step S58>

If n≠1, then the head to substrate distance is set to Dₙ₋₁ and processing is terminated. More specifically, since the R ink that is not contained in the prescribed regions is not less than the prescribed value and the specifications are not satisfied at the head to substrate distance Dₙ, then the head to substrate distance is taken one step back and set to the distance that satisfies the specifications.

Thus, by gradually increasing the head to substrate distance while confirming the ink that is not contained in the prescribed regions, and determining the largest value of the head to substrate distance which still satisfies the required specifications, it is possible to reduce the possibility of collision between the head and the substrate, as far as possible, while ensuring the required quality.

Moreover, as in the second embodiment, it is also possible to adopt a mode in which the head to substrate distance is gradually reduced while confirming the ink that is not contained in the prescribed regions.

Furthermore, as in the third embodiment, it is also possible to adopt a mode in which the amount of ink that is not contained in the prescribed regions is quantitatively evaluated for each of the head to substrate distances D₁ to D_{N}, in advance, and the head to substrate distance is specified on the basis of the results of this quantitative evaluation.

### <Composition of Inkjet Recording Apparatus>

<Composition of Image Formation Unit>

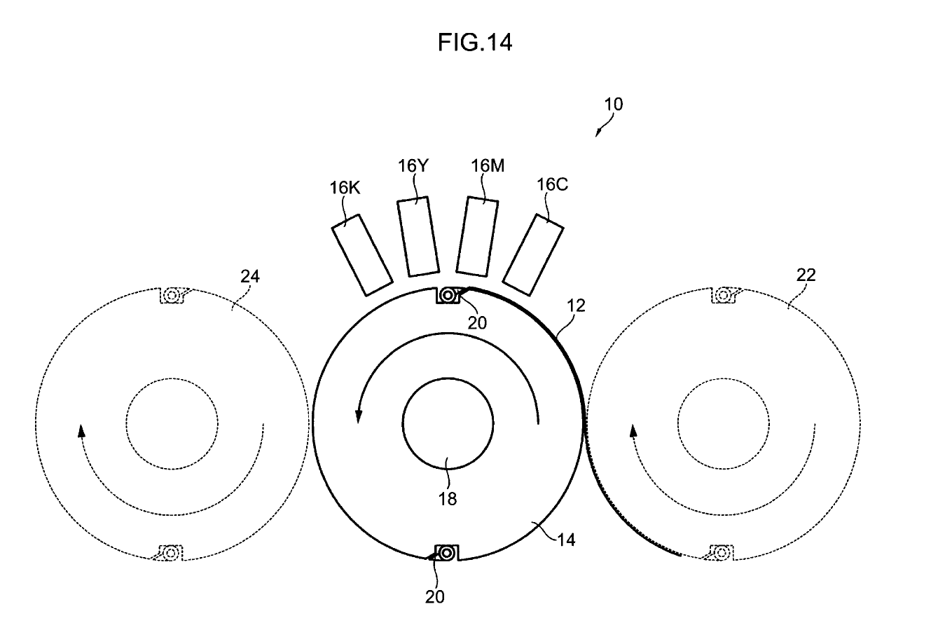

FIG. 14 is a schematic drawing showing an image formation unit 10 of an inkjet recording apparatus according to a further embodiment of the present invention.

As shown in FIG. 14, the inkjet recording apparatus conveys a sheet of paper 12, which is a recording medium, rotationally on an image formation drum 14 in the image formation unit 10. A color image is formed on a recording surface of the sheet of paper 12 by ejecting and depositing droplets of inks of respective colors of cyan (C), magenta (M), yellow (Y) and black (K) onto the recording surface of the sheet of paper 12 rotationally conveyed by the image formation drum 14, from four line heads 16C, 16M, 16Y and 16K, which are arranged so as to face the circumferential surface of the image formation drum 14.

The image formation drum 14 (corresponding to the movement device), which conveys the sheet of paper 12 (corresponding to the recording medium) is formed in a circular shape, and a rotational shaft 18 thereof is supported rotatably on bearings (not shown) arranged on a main body frame of the inkjet recording apparatus. The rotational shaft 18 is coupled with a motor through a rotation transmission mechanism (not shown), and is driven by the motor to rotate.

The image formation drum 14 has grippers 20 arranged at two positions on the circumferential surface thereof for gripping a leading end portion of the sheet of paper 12. The grippers 20 are driven so as to open and close respectively by opening and closing drive devices (not shown). The leading end portion of the sheet of paper 12 is gripped by the gripper 20 and thereby held on the circumferential surface of the image formation drum 14.

Furthermore, the circumferential surface of the image formation drum 14 is formed with a plurality of suction holes (not shown) in a prescribed pattern. Each suction hole is formed so as to pass through to the interior of the image formation drum 14. The air inside the image formation drum 14 is sucked with a vacuum pump (not shown). Therefore, the air is sucked to the interior of the drum 14 though the suction holes. The sheet of paper 12 wrapped about the circumferential surface of the image formation drum 14 is held by suction on the circumferential surface of the image formation drum 14 by the suction of the air through the suction holes.

In the present embodiment, the sheet of paper 12 is transferred to the image formation drum 14 by a conveyance drum 22, which is arranged in parallel with the image formation drum 14, and the sheet of paper 12 after the image formation is transferred onto a conveyance drum 24, which is similarly arranged in parallel with the image formation drum 14. The gripper 20 receives the sheet of paper 12 from the conveyance drum 22 of the preceding stage, in accordance with the timing, and the sheet of paper 12 after the image formation is transferred to the conveyance drum 24 of the following stage.

The four line heads 16C, 16M, 16Y and 16K (which correspond to the liquid ejection heads) are arranged radially with respect to the rotational shaft 18 of the image formation drum 14, at uniform intervals apart on a circle concentric with the rotating shaft 18. Under the control of a recording device (not shown), the line heads 16C, 16M, 16Y and 16K eject ink droplets perpendicularly to the circumferential surface of the image formation drum 14, and the ink droplets ejected toward the circumferential surface of the image formation drum 14 are deposited onto the sheet of paper 12 which is rotationally conveyed by the image formation drum 14, thereby forming a color image on the sheet of paper 12.

<Structure of Head>

Next, the structure of the line heads 16C, 16M, 16Y and 16K is described. Here, the respective line heads 16C, 16M, 16Y and 16K have the same structure, and the line head 16K for the black ink is described hereinafter as a representative example of these heads.

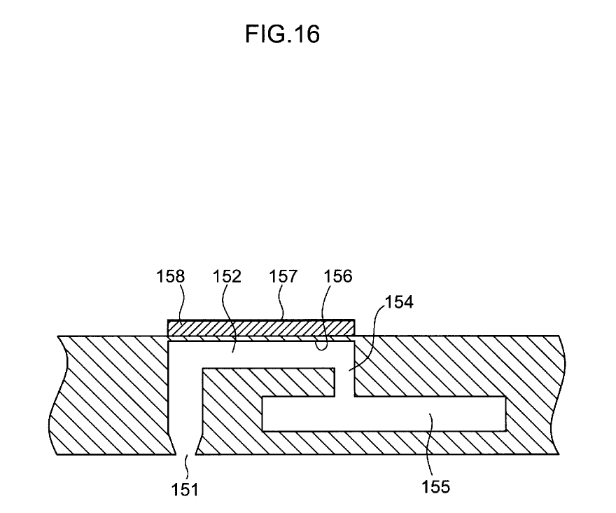

FIG. 15A is a plan view perspective diagram showing the structure of a head module 16K′, which constitutes the line head 16K, and FIG. 15B is a partial enlarged view of the same. FIG. 15C is a plan view perspective diagram showing the structure of the line head 16K. FIG. 16 is a cross-sectional diagram showing the inner structure of an ink chamber unit (a cross-sectional diagram along line 16-16 in FIGS. 15A and 15B).

In order to reduce the pitch of dots formed on the surface of the recording paper, it is necessary to reduce the pitch of the nozzles in the line head 16K. As shown in FIGS. 15A and 15B, the head module 16K′ has a structure in which a plurality of ink chamber units 153 are arranged in a matrix configuration according to a prescribed arrangement pattern (two-dimensional configuration), each ink chamber unit 153 being constituted of a nozzle 151, which is an ink droplet ejection aperture, and a pressure chamber 152 corresponding to the nozzle 151. Accordingly, a small pitch is achieved in the effective nozzle pitch projected to an alignment (namely, the projected nozzle pitch) in the lengthwise direction of the head (the main scanning direction which is perpendicular to the paper conveyance direction).

As shown in FIG. 15C, the line head 16K according to the present embodiment is composed as the line head having the nozzle row corresponding to the full width of the sheet of paper 12 by arranging and joining together the above-described head modules (head chips) 16K′ in the matrix configuration. Furthermore, although not shown in the drawings, it is also possible to form a line head by aligning short head modules in a row.

Each of the pressure chambers 152 arranged correspondingly to the nozzles 151 is formed with a substantially square planar shape, and a nozzle 151 and an ink inflow port 154 are arranged in the respective corner portions on a diagonal of this planar shape. The respective pressure chambers 152 connect with a common flow channel 155 through the ink inflow ports 154.

Piezoelectric elements 158 each having individual electrodes 157 are bonded to the diaphragm 156 which constitutes a ceiling face of the pressure chambers 152 and also serves as a common electrode. The piezoelectric element 158 is deformed by applying a drive voltage to the individual electrode 157, thereby causing a droplet of the ink in the pressure chamber 152 to be ejected through the nozzle 151. When the ink droplet is ejected, new ink is supplied to the pressure chamber 152 from the common flow channel 155 through the ink inflow port 154.

In the present embodiment, the piezoelectric elements 158 are employed as the ejection pressure generating devices for the ink droplet ejection from the nozzles 151 arranged in the line head 16K; however, it is also possible to employ a thermal method in which heaters are arranged inside the pressure chambers 152, and ink droplets are ejected by using the pressure of film boiling produced by heating by the heaters.

The high-density nozzle head of the present embodiment is achieved by arranging the plurality of ink chamber units 153 having the structure of this kind, in a lattice configuration according to a prescribed arrangement pattern in a row direction following the main scanning direction and an oblique column direction having a prescribed non-perpendicular angle θ with respect to the main scanning direction, as shown in FIG. 15B.

More specifically, by adopting the structure in which the plurality of ink chamber units 153 are arranged at a uniform pitch d in line with the direction forming the angle of θ with respect to the main scanning direction, the pitch P of the nozzles projected to the alignment in the main scanning direction is d×cos θ, and hence it is possible to treat the nozzles 151 as if they were arranged linearly at the uniform pitch of P. By means of this composition, it is possible to achieve the high-density nozzle configuration, in which the nozzles in the column projected to the alignment in the main scanning direction reach a total of 2400 nozzles per inch.

In carrying out the present invention, the arrangement structure of the nozzles is not limited to the example shown in the drawings, and it is also possible to apply various other types of nozzle arrangements, such as an arrangement structure having one nozzle row in the sub-scanning direction.

<Composition of Line Head Installation Section>

As shown in FIG. 14, the sheet of paper 12 which is held by suction on the circumferential surface of the image formation drum 14 and rotationally conveyed receives deposition of the droplets of the inks of the respective colors of C, M, Y and K, from the four line heads 16C, 16M, 16Y and 16K, which are arranged so as to face the circumferential surface of the image formation drum 14.

In order to form a color image of high accuracy, the line heads 16C, 16M, 16Y and 16K need to be arranged in accurate positions with respect to the image formation drum 14. More specifically, the nozzle faces of the line heads 16C, 16M, 16Y and 16K need to be arranged in parallel with the circumferential surface of the image formation drum 14 and at a uniform distance from the same.

Therefore, in the inkjet recording apparatus according to the present embodiment, the line heads 16C, 16M, 16Y and 16K are installed in the following manner. The installation sections of the line heads 16C, 16M, 16Y and 16K all have a common structure, and therefore an installation section of the black line head 16K is described as a representative example.

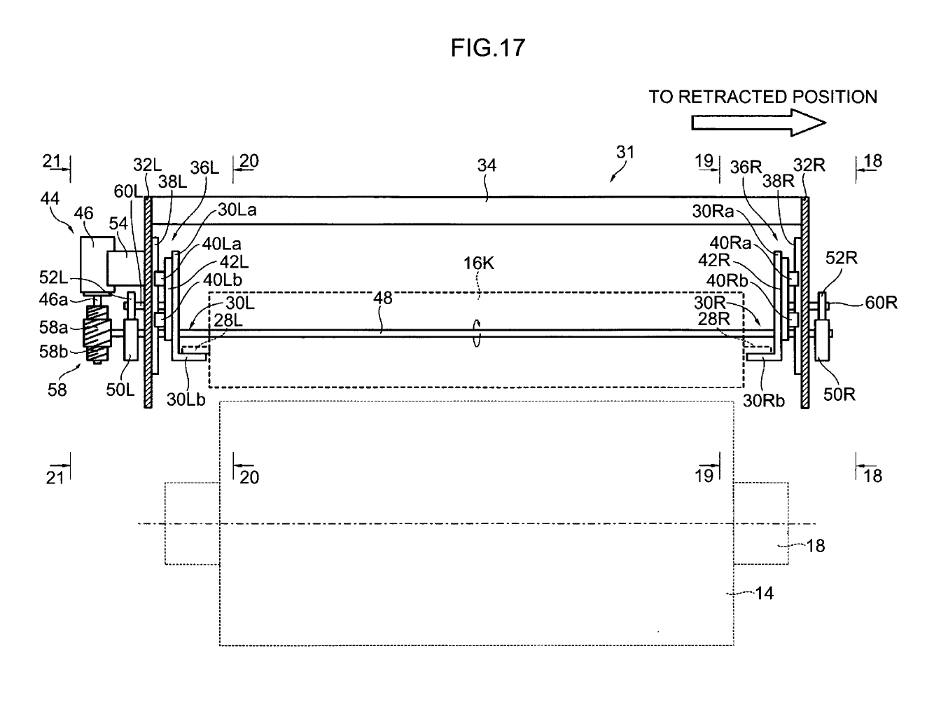

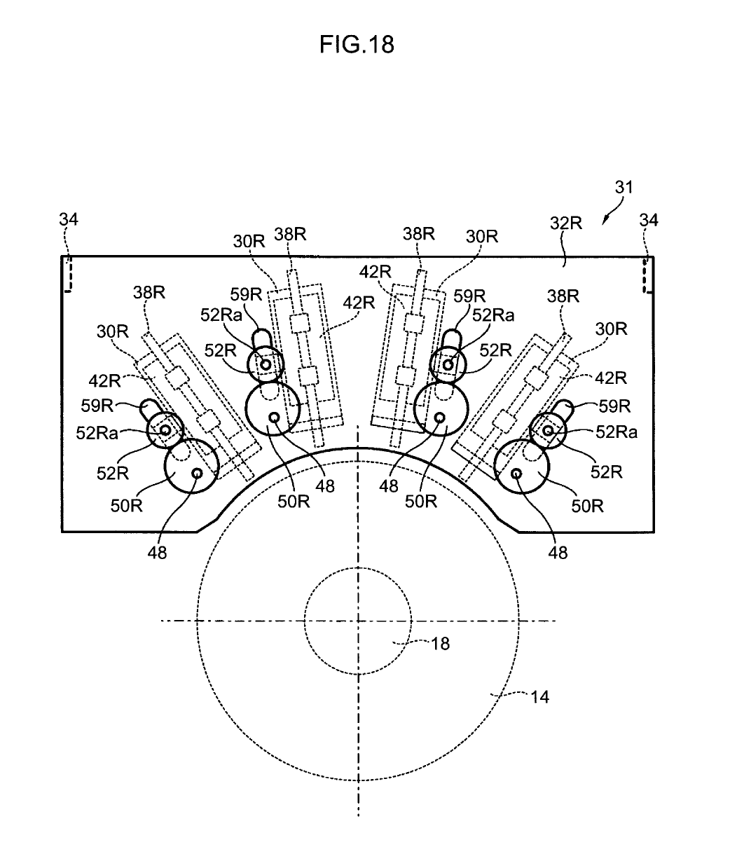

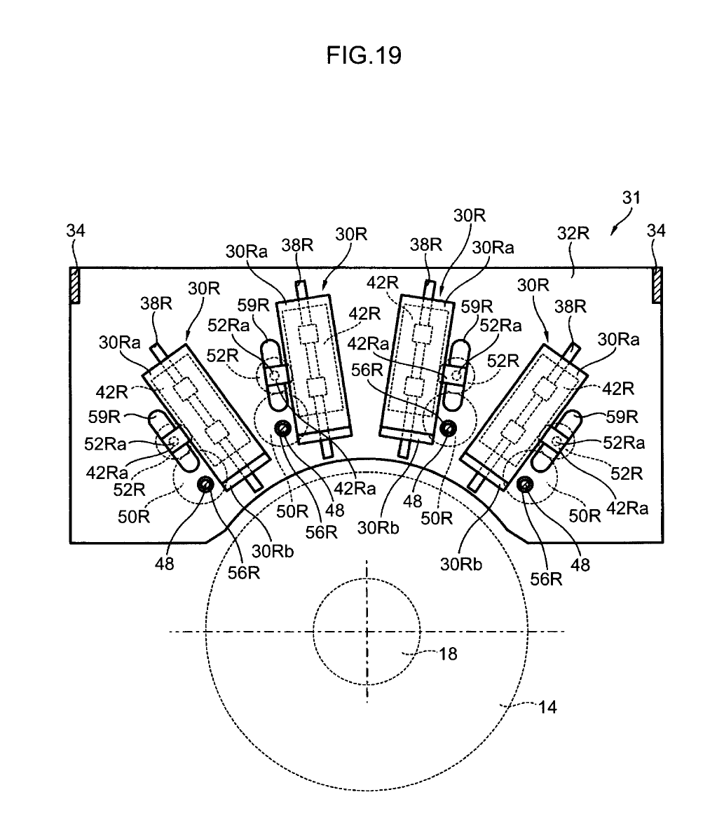

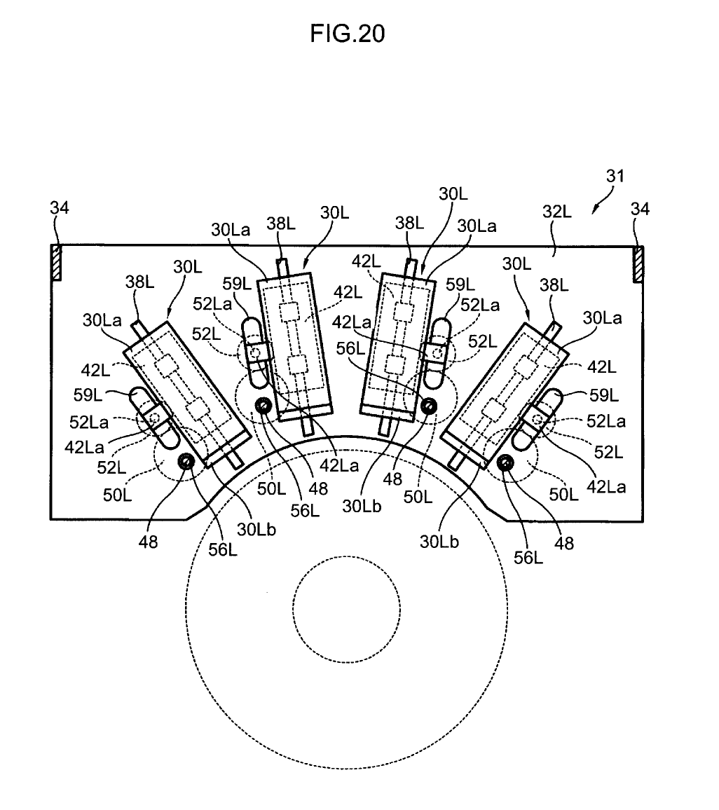

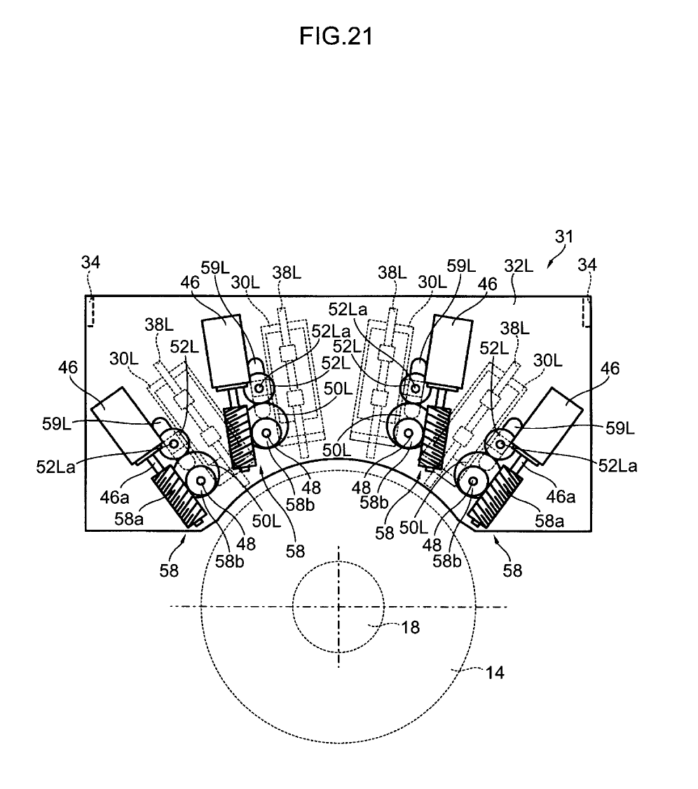

FIG. 17 is a front view diagram showing the structure of the installation section of the line head 16K. FIGS. 18, 19, 20 and 21 show a view along arrows 18-18, a view along arrows 19-19, a view along arrows 20-20, and a view along arrows 21-21, respectively, in FIG. 17.

As shown in FIG. 17, the line head 16K has supporting sections 28R and 28L at both end portions in the width direction, and is installed at a prescribed position by fixing the supporting sections 28R and 28L on a pair of pedestals 30R and 30L, which are arranged at the right-hand side and the left-hand side on the head supporting frame 31.

The head supporting frame 31 is constituted of a pair of right-hand side plate 32R and left-hand side plate 32L, and connecting plates 34, which connect the pair of side plates 32R and 32L. The right-hand side plate 32R and the left-hand side plate 32L are arranged in bilateral symmetry on both sides of the image formation drum 14, and are arranged perpendicularly with respect to the rotational shaft 18 of the image formation drum 14. The connecting plates 34 connect and unify the pair of side plates 32R and 32L, on the front and rear sides. The head supporting frame 31 is supported slidably on guide rails (not shown) which are installed on the main body frame of the inkjet recording apparatus. The head supporting frame 31 is arranged so as to be retractable to a prescribed retracted position, by sliding in parallel with the rotational shaft 18 of the image formation drum 14.

The pedestals 30R and 30L are installed on the inner sides of the side plates 32R and 32L through slide supporting mechanisms 36R and 36L, respectively.

The slide supporting mechanisms 36R and 36L are constituted of guide rails 38R and 38L, a set of sliders 40Ra, 40Rb, 40La and 40Lb, which slide on the guide rails 38R and 38L, and installation plates 42R and 42L, which are attached to the sliders 40Ra, 40Rb, 40La and 40Lb.

The guide rails 38R and 38L are attached to the inner sides of the side plates 32R and 32L, respectively. Each of the guide rails 38R and 38L is arranged in a straight line passing through the center of the image formation drum 14 (along a normal to the image formation drum 14).

The sliders 40Ra, 40Rb, 40La and 40Lb are arranged slidably on the guide rails 38L and 38R. Then, the sliders 40La, 40Lb, 40Ra and 40Rb can slide along straight lines passing through the center of the image formation drum 14. The sliders 40Ra, 40Rb, 40La and 40Lb are formed so as to be fixable to the guide rails 38R and 38L with bolts (not shown).

The installation plates 42R and 42L are formed in rectangular plate shapes and are fixed to the sliders 40Ra, 40Rb, 40La and 40Lb with bolts (not shown). The installation plates 42R and 42L, which are attached to the sliders 40Ra, 40Rb, 40La and 40Lb, are disposed perpendicularly with respect to the rotational shaft 18 of the image formation drum 14. By means of the sliders 40Ra, 40Rb, 40La and 40Lb, the installation plates 42R and 42L can slide along straight lines passing through the center of the image formation drum 14. The pedestals 30R and 30L are fixed to the installation plates 42R and 42L with bolts (not shown).

As shown in FIG. 17, the pedestals 30R and 30L are formed in L shapes by bending ends (lower ends) of rectangular plates at a right angle, and the pedestals 30R and 30L have perpendicular sections 30Ra and 30La, which are perpendicular to the rotational shaft 18 of the image formation drum 14, and horizontal sections 30Rb and 30Lb, which are parallel to the rotational shaft 18 of the image formation drum 14. The pedestals 30R and 30L are installed on the slide supporting mechanisms 36R and 36L by fixing the vertical sections 30Ra and 30La to the installation plates 42R and 42L of the slide supporting mechanisms 36R and 36L with bolts (not shown).

The pedestals 30R and 30L installed on the slide supporting mechanisms 36R and 36L are installed in such a manner that the vertical sections 30Ra and 30La are disposed perpendicularly with respect to the rotational shaft 18 of the image formation drum 14 and the horizontal sections 30Rb and 30Lb are disposed in parallel with the rotational shaft 18 of the image formation drum 14, as shown in FIG. 17. The pedestals 30R and 30L installed on the slide supporting mechanisms 36R and 36L are supported slidably along straight lines passing through the center of the image formation drum 14, by the slide supporting mechanisms 36R and 36L, and are supported raisably and lowerably perpendicularly with respect to the circumferential surface of the image formation drum 14.

The pedestals 30R and 30L which are supported raisably and lowerably perpendicularly with respect to the circumferential surface of the image formation drum 14 in this way are driven to be raised and lowered by an elevator drive mechanism 44 (which corresponds to the elevator device).

The elevator drive mechanism 44 includes: a pulse motor 46; a rotation drive shaft 48, which is driven to rotate by the pulse motor 46; a pair of eccentric cams 50R and 50L, which are installed on the right-hand end and the left-hand end of the rotation drive shaft 48; and a pair of idle cams 52R and 52L, which are installed on the installation plates 42R and 42L and abut to the eccentric cams 50R and 50L, respectively.

The pulse motor 46 is installed through a bracket 54 on an outer side surface of one side plate 32L, and an output shaft 46a thereof is disposed perpendicularly with respect to the rotational shaft 18 of the image formation drum 14.

The rotation drive shaft 48 is arranged so as to span between the side plates 36R and 36L, and is disposed in parallel with the rotational shaft 18 of the image formation drum 14. The rotation drive shaft 48 is supported rotatably on bearings 56R and 56L arranged on the side plates 32R and 32L.

The rotation of the pulse motor 46 is transmitted to the rotation drive shaft 48 through a worm gear 58, and a worm 58a forming the worm gear 58 is installed on the output shaft 46a of the pulse motor 46. On the other hand, a worm gear 58b meshing with the worm 58a is installed on the rotation drive shaft 48, whereby the rotation of the pulse motor 46 is transmitted to the rotation drive shaft 48.

The eccentric cams 50R and 50L are formed in a circular disk shape, and are installed on the rotation drive shaft 48 with eccentrically set the rotational centers thereof. The eccentric cams 50R and 50L are arranged to the outer sides of the side plates 32R and 32L, respectively, and are disposed perpendicularly with respect to the rotational shaft 18 of the image formation drum 14.

The idle cams 52R and 52L are formed in a circular disk shape, and are arranged on the eccentric cams 50R and 50L in such a manner that the circumferential surfaces of the idle cams 52R and 52L abut to the circumferential surfaces of the eccentric cams 50R and 50L, respectively. The idle cams 52R and 52L are supported rotatably on supporting shafts 52Ra and 52La, which are disposed in parallel with the rotational shaft 18 of the image formation drum 14. The supporting shafts 52Ra and 52La are arranged in parallel with the rotational shaft 18 of the image formation drum 14, so as to pass through elongated holes 59R and 59L formed in the side plates 32R and 32L, and the base end portions of the supporting shafts 52Ra and 52La are fixed to shaft supporting sections 42Ra and 42La, which are formed integrally with the installation plates 42R and 42L. The elongated holes 59R and 59L are formed in parallel with the guide rails 38R and 38L, whereby the idle cams 52R and 52L can move in parallel with the guide rails 38R and 38L.

According to the elevator drive mechanism 44 composed as described above, when the pulse motor 46 is driven and the rotation drive shaft 48 is caused to rotate, the right and left pair of eccentric cams 50R and 50L also rotate, thereby raising and lowering the idle cams 52R and 52L perpendicularly with respect to the circumferential surface of the image formation drum 14. By raising and lowering the idle cams 52R and 52L perpendicularly with respect to the circumferential surface of the image formation drum 14, the installation plates 42R and 42L connected to the idle cams 52R and 52L are also raised and lowered perpendicularly with respect to the circumferential surface of the image formation drum 14, as a result of which the pedestals 30R and 30L are raised and lowered perpendicularly with respect to the circumferential surface of the image formation drum 14.

The pedestals 30R and 30L are fixed to the side plates 32R and 32L by fixing the sliders 40Ra, 40Rb, 40La and 40Lb to the guide rails 38R and 38L with bolts (not shown). Each of the line heads 16C, 16M, 16Y and 16K is installed in a state where the pedestals 30R and 30L are fixed to the side plates 32R and 32L.

The line head installation sections have the composition described above.

The mechanism for raising and lowering the line head is not limited to that of the present embodiment, and it is also possible to use an elevator mechanism based on a ball screw, for example.

### <Description of Elevator Control System>

Next, the composition of a line head elevator control system is described. The image formation unit 10 according to the present embodiment adjusts the gaps for the respective line heads by controlling the elevator mechanisms of the line heads described above.

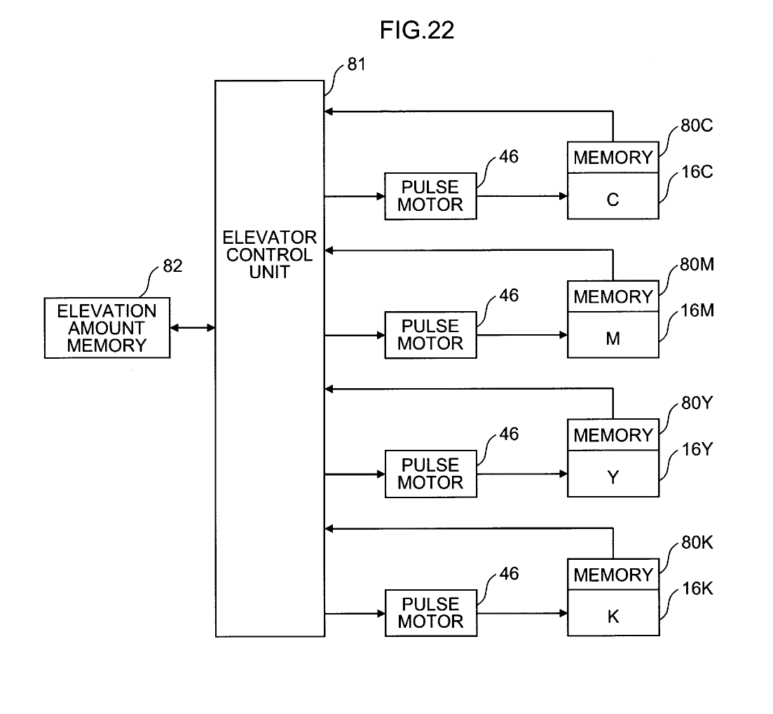

FIG. 22 is a principal block diagram showing the line head elevator control system. The image formation unit 10 of the inkjet recording apparatus includes an elevator control unit 81, which controls rotation of the pulse motors 46 installed respectively on the line heads 16C, 16M, 16Y and 16K, and an elevation amount memory 82, which can store an amount of elevation of each line head (current position of each line head).

The line heads 16C, 16M, 16Y and 16K have memories 80C, 80M, 80Y and 80K for temporarily storing image data according to which the line heads 16C, 16M, 16Y and 16K eject ink droplets, respectively. As described hereinafter, in the present embodiment, the memories 80C, 80M, 80Y and 80K are used as memories for storing data indicating intrinsic elevation information of the line heads 16C, 16M, 16Y and 16K, and the elevator control unit 81 drives the pulse motors 46 of the line heads 16C, 16M, 16Y and 16K in accordance with the height information read out from the memories 80C, 80M, 80Y and 80K.

The elevator drive mechanism 44 converts an amount of rotation (angle of rotation) of each eccentric cam 50 (50R or 50L) into an amount of linear movement of each slider 40 (40Ra, 40Rb, 40La or 40Lb) corresponding to the amount of elevation of each line head 16 (16C, 16M, 16Y or 16K). The relationship between the angle of rotation of the eccentric cam 50 and the amount of elevation of the line head 16 is not linear.

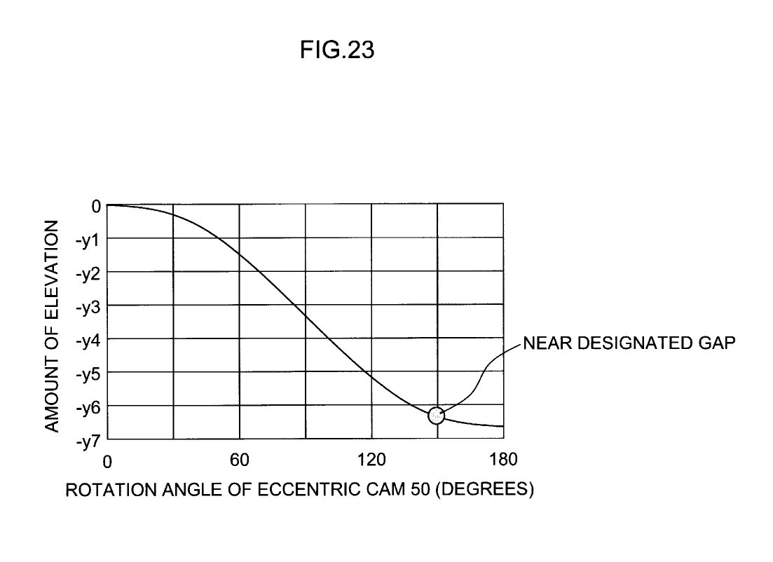

FIG. 23 is a graph showing the relationship between the angle of rotation of the eccentric cam 50 and the amount of elevation of the line head 16. As shown in FIG. 23, when the angle of rotation of the eccentric cam 50 is 0 degrees, the line head 16 is situated in an uppermost position, and as the eccentric cam 50 rotates, the line head 16 descends in accordance with the angle of rotation and the amount of eccentricity of the eccentric cam 50.

Consequently, the elevator control unit 81 includes a correlation table by which an amount of elevation (elevation distance) of each of the line heads 16C, 16M, 16Y and 16K can be calculated in accordance with the relationship shown in FIG. 23, from the number of pulses supplied to the pulse motor 46 and the amount of displacement of the eccentric cam 50.

<Installation of Line Heads>

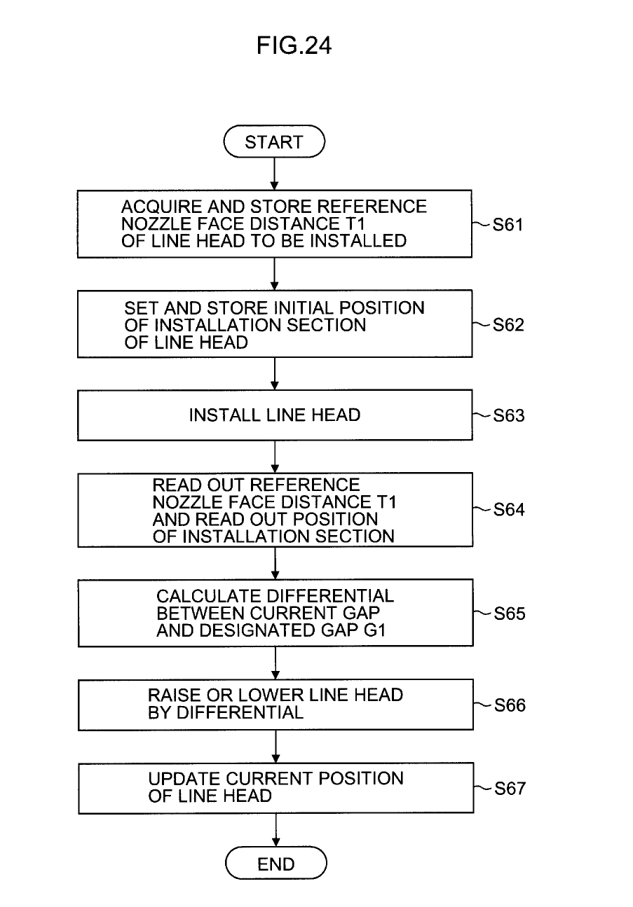

Next, gap adjustment when installing the line heads on the above-described installation sections is explained. FIG. 24 is a flowchart showing automatic gap adjustment when installing the line head.

When the line head is installed on the installation section, it is necessary to calculate in advance the reference nozzle face distance T1 for the line head (step S61).

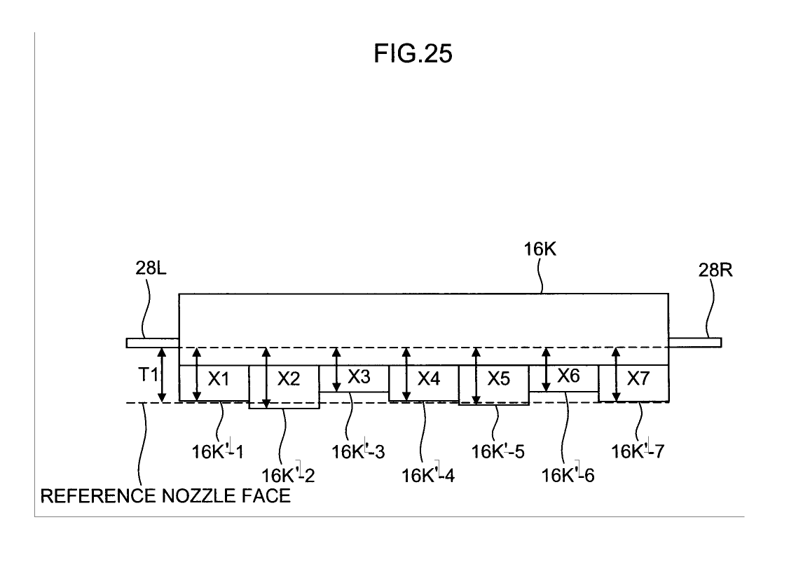

FIG. 25 is a schematic drawing of the line head 16K viewed from the front side (the same direction as FIG. 17). Here, the line head 16K includes seven head modules 16K′-1 to 16K′-7.

Firstly, the data of distances from the lower ends of the supporting sections 28R and 28L of the line head 16K to the nozzle faces of the head modules 16K′-1 to 16K′-7 is acquired. The head modules 16K′-1 to 16K′-7 each have different distances from the lower ends of the supporting sections 28R and 28L to the nozzle faces thereof, due to manufacturing errors and installation errors. In the example shown in FIG. 25, the distances are X1 in the case of the head module 16K′-1, X2 in the case of head module 16K′-2, . . . , and X7 in the case of the head module 16K′-7.

From this distance data, the reference nozzle face distance T1, which is the intrinsic elevation information of the line head 16K, is calculated. Here, the reference nozzle face distance T1 is the sum of the average value Xa of the distances X1, X2, . . . , and X7, and the standard deviation Sx, and is expressed as:

T1=Xa+Sx.

The reference nozzle face distance T1 thus calculated is stored in the memory 80K of the line head 16K (see FIG. 22).

Each of the line heads 16C, 16M, 16Y and 16K is installed on the pedestals 30R and 30L. Therefore, the pedestals 30R and 30L for installing each of the line heads 16C, 16M, 16Y and 16K need to be set previously to prescribed positions (elevations) (step S62). This operation is carried out by using a recording head jig 16D.

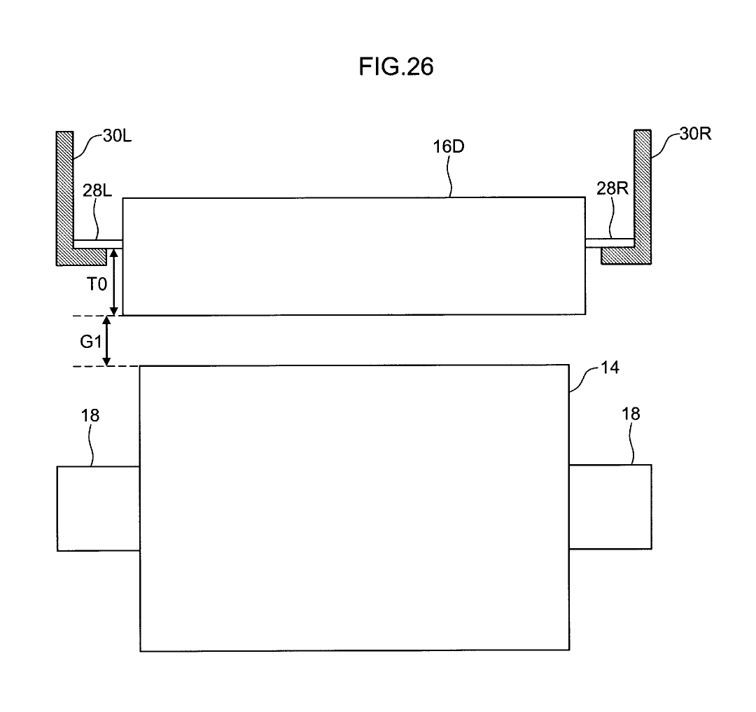

FIG. 26 is a schematic drawing for describing the initial positional settings of the pedestals 30R and 30L using the recording head jig 16D, and shows a view in the same direction as FIG. 17. As shown in FIG. 26, the recording head jig 16D has supporting sections 28R and 28L in both end sections in the width direction, similarly to the line heads 16C, 16M, 16Y and 16K. Furthermore, the recording head jig 16D is composed in such a manner that the distance from the lower end of each of the supporting sections 28R and 28L to the lower surface facing the circumferential surface of the image formation drum 14 is the nozzle face design distance of T0.

The recording head jig 16D is installed at a prescribed position on the image formation unit 10 by fixing the supporting sections 28R and 28L to the pair of pedestals 30R and 30L, which are arranged on the head supporting frame 31.

After the installation of the recording head jig 16D, the user controls the elevator control unit 81 through a user interface (not shown) to raise and lower the recording head jig 16D installed on the pedestals 30R and 30L in such a manner that the distance between the lower surface of the recording head jig 16D and the circumferential surface of the image formation drum 14 is a designated gap G1.

The designated gap G1 is set to the distance that is optimal for ejecting ink from the nozzles 151 of the line heads 16C, 16M, 16Y and 16K. The constituent parts of the elevator drive mechanism 44 are located in such a manner that the designated gap G1 is set when the angle of rotation of the eccentric cam 50 is around 150 degrees as shown in FIG. 23.

Once the distance between the lower surface of the recording head jig 16D and the circumferential surface of the image formation drum 14 has been set to the designated gap G1, the user enters the fact that setting of the designated gap G1 has been completed, through the user interface (not shown). Upon this entering operation, the elevator control unit 81 stores the current position (elevation position) of the elevator drive mechanism 44 in the elevation amount memory 82. Here, the distance from the lower end of each of the supporting sections 28R and 28L to the circumferential surface of the image formation drum 14 is stored as T0+G1; however, it is also possible to store just the elevation information of the installed line head (in this case, the nozzle face design distance T0 of the recording head jig 16D), or to store the current angle of rotation of the eccentric cam 50.

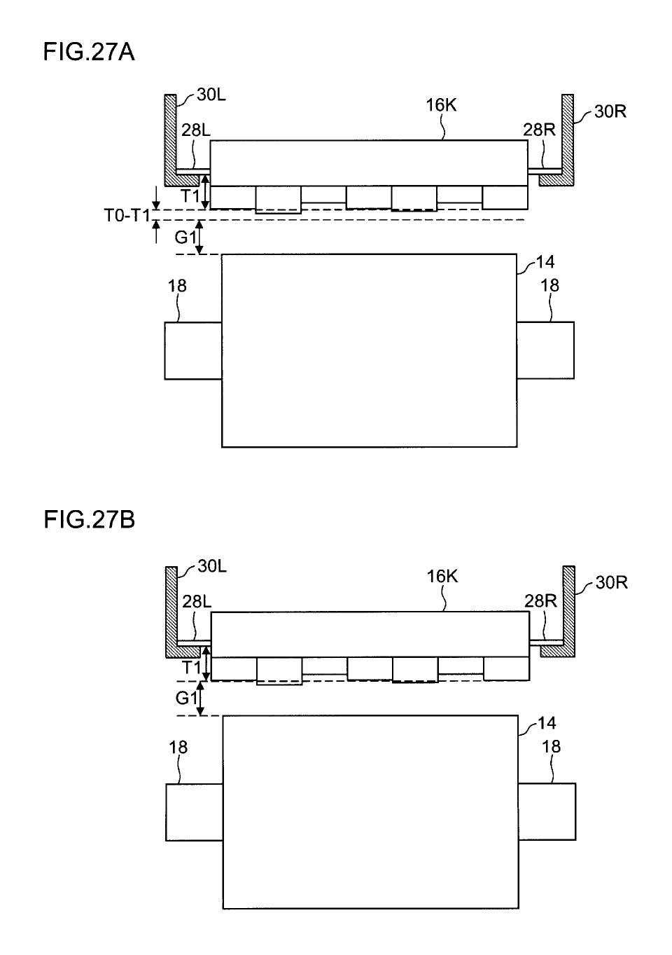

Thereupon, the user removes the recording head jig 16D from the supporting sections 28R and 28L, and then fixes the line head 16K that is actually to be installed, to the supporting sections 28R and 28L, as shown in FIG. 27A (step S63).

The line head 16K has the reference nozzle face distance of T1, and therefore the distance between the reference nozzle face of the line head 16K and the circumferential surface of the image formation drum 14 when the recording head jig 16D is replaced with the line head 16K, in other words, the current gap distance, is now (T0+G1)−T1. The elevator control unit 81 controls the elevator drive mechanism 44 in such a manner that this current gap distance becomes the designated gap G1.

More specifically, the elevator control unit 81 firstly reads out the reference nozzle face distance T1 from the memory 80K of the line head 16K that has been installed. The elevator control unit 81 then reads out the current position T0+G1 of the elevator drive mechanism 44 from the elevation amount memory 82 (step S64). From this data, the differential (T0−T1) between the designated gap G1 and the distance from the reference nozzle face of the line head 16K to the circumferential surface of the image formation drum 14 is calculated (step S65).

Moreover, the elevator control unit 81 calculates the number of pulses to be supplied to the pulse motor 46, from the differential (T0−T1) and the correlation table, and controls the pulse motor 46 by means of the calculated number of pulses (step S66). In this way, the line head 16K is raised or lowered by the distance differential (T0−T1), whereby the distance between the reference nozzle face of the line head 16K and the circumferential surface of the image formation drum 14 can be set to the designated gap G1 (FIG. 27B).

After adjustment of the gap, the elevator control unit 81 stores the fact that the current distance from the lower ends of the supporting sections 28L and 28R to the circumferential surface of the image formation drum 14 is T1+G1, in the elevation amount memory 82 (step S67).

In this way, in the inkjet recording apparatus according to the present embodiment, since the initial position of the elevator drive mechanism 44 is set by using the recording head jig 16D having the known nozzle face design distance (T0), and the line head having the previously calculated reference nozzle face distance (T1) is then installed subsequently, then it is possible to adjust the gap readily, even when there are errors such as the manufacturing error of the recording head (line head 16K) and the manufacturing errors and installation errors of the ejection nozzle members (head modules 16K′).

Furthermore, by providing the reference nozzle face distance (T1), the reliability of the gap adjustment value is improved, in addition to which, by setting the reference nozzle face distance as the sum of the average value of the ejection nozzle members (head modules 16K′) and the standard deviation, it is possible to avoid contact between the nozzle face and the recording medium.

Moreover, since no special adjustment mechanism for adjusting the gap is required, then space savings can be made.

In the present embodiment, the gap is adjusted by raising or lowering the line head; however, it is also possible to adjust the gap by raising or lowering the recording medium.

<Replacement of Line Heads>

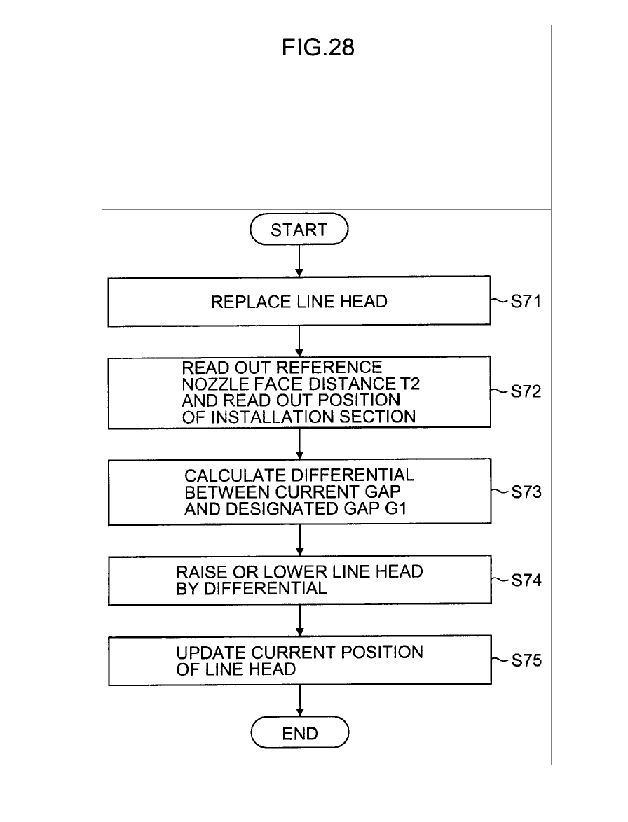

In the inkjet recording apparatus according to the present embodiment, the gap adjustment can be carried out readily, even when the line head is replaced. FIG. 28 is a flowchart showing automatic gap adjustment when the line head is replaced.

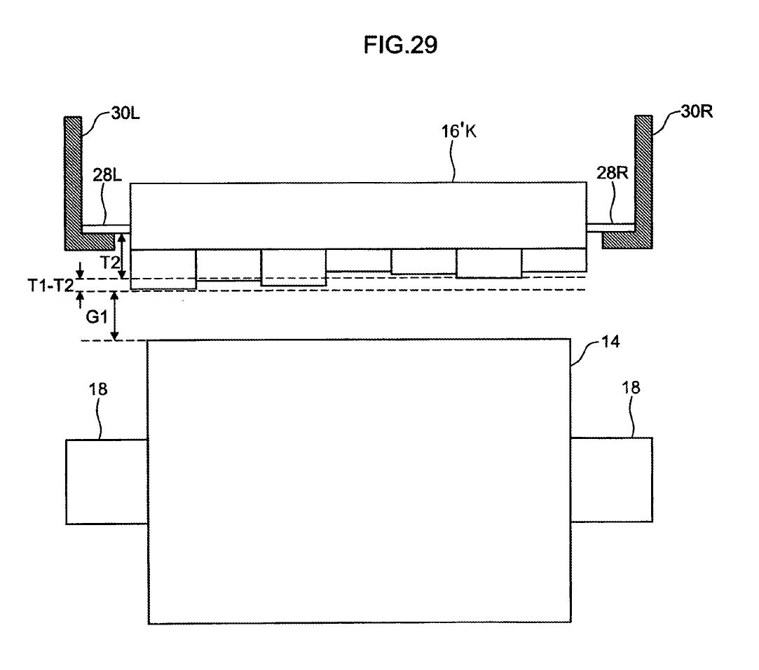

A case is described here in which the line head 16K having the reference nozzle face distance T1 has been installed so as to have the designated gap G1 as shown in FIG. 27B (the state where the distance from the lower end of each of the supporting sections 28R and 28L to the circumferential surface of the image formation drum 14 is T1+G1), and this line head 16K is then replaced with another line head 16′K having a reference nozzle face distance of T2 as shown in FIG. 29.

The user removes the line head 16K from the supporting sections 28R and 28L, and then fixes the newly installed line head 16′K to the supporting sections 28R and 28L (step S71).

Upon detecting the replacement of the line head, the elevator control unit 81 reads out the reference nozzle face distance T2 of the line head 16′K from the memory 80K of the line head 16′K. Furthermore, the elevator control unit 81 then reads out the current position T1+G1 from the elevation amount memory 82 (step S72). From the read data, the current distance (T1+G1)−T2 between the reference nozzle face of the line head 16′K and the circumferential surface of the image formation drum 14 is calculated, and the differential (T1−T2) between this distance and the designated gap G1 is calculated (step S73).

The elevator control unit 81 calculates the number of pulses to be supplied to the pulse motor 46, from the differential (T1−T2) and the correlation table, and controls the pulse motor 46 by means of the calculated number of pulses. In this way, the line head 16′K is raised or lowered by the distance differential (T1−T2), whereby the distance between the reference nozzle face of the line head 16′K and the circumferential surface of the image formation drum 14 can be set to the designated gap G1 (step S74).

Similarly to the foregoing, after the adjustment of the gap, the current position of the elevator drive mechanism 44 is stored in the elevator amount memory 82 (step S75).

In this way, even when the line head is replaced, the amount of elevation required is calculated automatically on the basis of the reference nozzle face distance before and after installation of the line head, and the pulse motor is controlled in accordance with the calculated amount of elevation. Therefore, it is possible to adjust the line head readily to the designated gap.

The user is also able to change the designated gap G1 through the user interface (not shown). When the designated gap has been changed to G2, the elevator control unit 81 is able to adjust the distance between the line head and the circumferential surface of the image formation drum to the new designated gap G2, by controlling the pulse motor 46 in accordance with the differential (G1−G2) between the new and old designated gaps.

Moreover, the gap between the nozzle face of the line head and the recording medium varies with the thickness of the sheet of paper 12, and therefore it is also possible to adjust the gap automatically to a designated gap by having the user enter the paper thickness through the user interface (not shown). In this case, when the designated gap is G1 and the input thickness of the sheet of paper 12 is T_{P}, then the elevator control unit 81 controls the elevation of the line head in such a manner that the distance between the reference nozzle face of the line head and the circumferential surface of the image formation drum 14 becomes (G1+T_{P}).

Further, it is also possible to select the name of the recording medium, rather than inputting the paper thickness. In this case, a table indicating a relationship between the names of the recording media and the thicknesses is stored in a memory, and the thickness of the recording medium can be acquired by reading out the thickness of the selected recording medium name from the table.

Furthermore, the scope of application of the present invention is not limited to the print method using the line type head, and the present invention can also be applied to a serial method in which printing is performed in the width direction of the sheet of paper 12 by employing a short head that is shorter than the dimension in the width direction (main scanning direction) of the sheet of paper 12 and performing a scanning action in the width direction of the sheet of paper 12 with the short head, and after completing one printing action in the width direction, the sheet of paper 12 is moved by a prescribed amount in a direction (sub-scanning direction) perpendicular to the width direction, printing in the width direction of the paper 12 is performed on the next print region, and by repeating this operation, printing is performed over the whole surface of the print area of the sheet of paper 12.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid ejection apparatus, comprising:
a liquid ejection head which has nozzles configured to eject droplets of liquid toward a recording medium;
a movement device which is configured to cause relative movement of the liquid ejection head and the recording medium;
an elevator device which is configured to change a distance between the liquid ejection head and the recording medium;
a recording device which is configured to carry out recording onto the recording medium by driving the liquid ejection head to eject and deposit the droplets of the liquid onto the recording medium from the nozzles while driving the movement device to cause the relative movement of the liquid ejection head and the recording medium;
an evaluation acquisition device which is configured to acquire droplet deposition performance of the liquid ejection head evaluated in accordance with results of the recording carried out on the recording medium; and
a setting device which is configured to set the distance to as large a value as possible while satisfying droplet deposition performance required for the liquid ejection head, in accordance with the acquired droplet deposition performance.

2. The liquid ejection apparatus as defined in claim 1, wherein:
the elevator device is configured to discretely change the distance; and
the setting device is configured to set the distance to a value larger than a current value when the acquired droplet deposition performance is not worse than the required droplet deposition performance.

3. The liquid ejection apparatus as defined in claim 1, wherein:
the elevator device is configured to discretely change the distance; and
the setting device is configured to set the distance to a value smaller than a current value when the acquired droplet deposition performance is worse than the required droplet deposition performance.

4. The liquid ejection apparatus as defined in claim 1, wherein:
the evaluation acquisition device is configured to previously acquire droplet deposition performances at a plurality of distances between the liquid ejection head and the recording medium; and
the setting device is configured to set the distance to a largest value which satisfies the required droplet deposition performance in accordance with the acquired droplet deposition performances at the plurality of distances.

5. The liquid ejection apparatus as defined in claim 4, wherein the evaluation acquisition device acquires a droplet deposition performance between the plurality of distances by interpolating the acquired droplet deposition performances at the plurality of distances.

6. The liquid ejection apparatus as defined in claim 1, wherein:
the liquid is image forming ink;
the liquid ejection head is configured to form an image on the recording medium by ejecting and depositing droplets of the image forming ink onto the recording medium; and
the evaluation acquisition device is configured to acquire, as the droplet deposition performance of the liquid ejection head, deposition position deviations of the droplets having been deposited on the recording medium.

7. The liquid ejection apparatus as defined in claim 1, wherein:
the liquid is image forming ink;
the liquid ejection head is configured to form an image on the recording medium by ejecting and depositing droplets of the image forming ink onto the recording medium; and
the evaluation acquisition device is configured to acquire, as the droplet deposition performance of the liquid ejection head, an optical density of the image having been formed on the recording medium.

8. The liquid ejection apparatus as defined in claim 1, wherein:
the liquid is conductive ink;
the recording medium is a substrate;
the liquid ejection head is configured to form electrical wiring on the substrate by ejecting and depositing droplets of the conductive ink onto the substrate; and
the evaluation acquisition device is configured to acquire, as the droplet deposition performance of the liquid ejection head, an electrical resistance of the electrical wiring having been formed on the substrate.

9. The liquid ejection apparatus as defined in claim 1, wherein:
the liquid is color ink;
the recording medium is a substrate on which partitions are formed;
the liquid ejection head is configured to form pixels of a color filter within the partitions on the substrate by ejecting and depositing droplets of the color ink within the partitions on the substrate; and
the evaluation acquisition device is configured to acquire, as the droplet deposition performance of the liquid ejection head, information on whether the color ink is contained within each of the pixels of the color filter having been formed.

10. The liquid ejection apparatus as defined in claim 1, wherein the evaluation acquisition device includes an input device which is configured to allow a user to enter results of evaluation based on the results of the recording carried out on the recording medium.

11. The liquid ejection apparatus as defined in claim 1, wherein the evaluation acquisition device includes an evaluation device which is configured to evaluate the droplet deposition performance of the liquid ejection head in accordance with the results of the recording carried out on the recording medium.

12. The liquid ejection apparatus as defined in claim 1, wherein:
the nozzles of the liquid ejection head are arranged through a length corresponding to a full recordable width of the recording medium; and
the movement device is configured to cause the relative movement of the liquid ejection head and the recording medium just once.

13. The liquid ejection apparatus as defined in claim 1, wherein:
the liquid ejection head includes a plurality of head modules;
the evaluation acquisition device is configured to acquire, as the droplet deposition performance of the liquid ejection head, droplet deposition performance of one of the head modules having lowest droplet deposition performance among the head modules; and
the setting device is configured to set a distance between the head module having the lowest droplet deposition performance and the recording medium to as large a value as possible while satisfying the droplet deposition performance required for the liquid ejection head.

14. The liquid ejection apparatus as defined in claim 1, comprising:
a plurality of the liquid ejection heads which are configured to eject droplets of respectively different liquids, wherein:
the movement device is configured to cause relative movement of each of the liquid ejection heads and the recording medium;
the elevator device is configured to change a distance between each of the liquid ejection heads and the recording medium;
the evaluation acquisition device is configured to acquire droplet deposition performance of each of the liquid ejection heads evaluated in accordance with results of the recording carried out on the recording medium; and
the setting device is configured to set the distance for each of the liquid ejection heads in accordance with the acquired droplet deposition performance of each of the liquid ejection heads.

15. A control method for a liquid ejection apparatus which includes: a liquid ejection head which has nozzles configured to eject droplets of liquid toward a recording medium; a movement device which is configured to cause relative movement of the liquid ejection head and the recording medium; an elevator device which is configured to change a distance between the liquid ejection head and the recording medium; and a recording device which is configured to carry out recording onto the recording medium by driving the liquid ejection head to eject and deposit the droplets of the liquid onto the recording medium from the nozzles while driving the movement device to cause the relative movement of the liquid ejection head and the recording medium, the method comprising:
an evaluation acquisition step of acquiring droplet deposition performance of the liquid ejection head evaluated in accordance with results of the recording carried out on the recording medium; and
a setting step of setting the distance to as large a value as possible while satisfying droplet deposition performance required for the liquid ejection head, in accordance with the acquired droplet deposition performance.
